(19) United States
(12) Patent Application Publication
(10) Pub. No.: US 2023/0296922 A1
(43) Pub. Date: Sep. 21, 2023

(54) CONNECTOR SUITABLE FOR ELECTRONIC GLASSES AND ELECTRONIC GLASSES COMPRISING SUCH A CONNECTOR

(71) Applicant: Morrow N.V., Zwijnaarde (BE)

(72) Inventors: Anna Kmecová, Oostende (BE); Paresh Limaye, De Pinte (BE); Philip Ekkels, Drongen (BE); Lucas Jacky P. Van Dorpe, Deinze (BE); Philip Madden, Braschaat (BE); Tim Ruytjens, Mortsel (BE)

(21) Appl. No.: 18/041,491

(22) PCT Filed: Aug. 12, 2021
(86) PCT No.: PCT/EP2021/072546

§ 371 Date: Feb. 13, 2023

(30) Foreign Application Priority Data
Aug. 14, 2020 (NL) 2026272

(51) Int. Cl. G02C 7/08; G02C 7/10

(52) U.S. Cl. CPC G02C 7/083; G02C 7/101; G02C 2202/18

(57) ABSTRACT

The present disclosure relates to a connector suitable for providing an electronic connection between a control unit and at least one electro-optical component arranged in an electroactive lens for electronic glasses, wherein the electroactive lens has a circumferential rim along which a plurality of exposed contact areas are arranged providing electrical contact with the electro-optical component, the connector comprising a flexible cable connected to the control unit and comprising connection portions to connect to a compressible connector module, a compressible connector module, positioned between the circumferential rim of the lens and the flexible cable and configured to provide an electrical connection between the exposed contact areas and the connection portions, wherein the compressible connector module is configured to be compressed between the lens and the frame, and a sealing unit configured to enclose at least the conductive connection portions of the flexible cable and the compressible connector module.

The present disclosure relates to a connector suitable for providing an electrical connection between a control unit and at least one electro-optical component arranged in an electroactive lens for electronic glasses, and to electronic glasses comprising such a connector.

“Electronic glasses”, as used in this application, includes any glasses wherein electronics are integrated into an eyeglasses frame.

Many types of electronic glasses, wherein an electronic device is integrated into an eyeglass frame, are available. In some of these glasses, an electronic device is merely attached to a frame. In others, the electronic device is more closely connected to the eyeglass function: for instance, glasses are known wherein a camera is integrated in such a way that a user can photograph or film what they are looking towards. In yet other electronic glasses, the electronic device interacts with the lenses in the eyeglasses: this is for instance the case with ‘active’ 3D glasses, in which the left and right lens are blocked in an alternating fashion, and with other types of electro-active lenses, such as lenses for tuneable transmission of light. The present disclosure focuses in particular on types of electronic glasses in which at least one of the lenses comprises at least one electro-optical component, controllable by control electronics in the frame.

In a majority of the existing electronic glasses, the electronics are distributed on either side of the front part of the frame: for instance, a power source might be arranged on one side and control electronics on the other side. This also means that a connecting cable is required at least for power transfer and in many cases also information transfer. Such a cable must then be integrated in some way along or through the front part of the frame. Furthermore, some kind of electrical connection must be provided between the electronics and the electro-optical component(s) in the lens(es).

Additionally, the importance of water-resistance is increasing in portable electronic devices, as today's consumers expect to be able to use their devices anywhere anytime. Depending on the intended use, e.g. outdoor activities where there is a higher probability of moisture intrusion, basic splash-resistance (IPX4) and even protection against short immersion in water (IPX7) are becoming more and more standard. Especially in eyewear water-resistance is of great importance. Besides being used outdoor, glasses are inherently subjected to dirt (dust and grease) and/or sweat. To ensure a good vision with your eyewear, cleaning them on a daily basis can be necessary. To allow proper cleaning, a minimum IPX4 level of water-resistance is needed.

In many existing electronic glasses, the frame is designed for a specific application containing well-tailored cavities to house all electronics and connectors. These cavities are then sealed with additional plastic and/or metal covers which can be screwed and/or glued onto the frame. To provide the required level of water-resistance, the cover can be tightly and permanently attached with a moisture resistant adhesive or resin. These existing systems however have a few drawbacks: they are not flexible to different applications or even slightly different lenses and it may be difficult to replace the electronics.

Furthermore, in many existing electronic glasses, a flexible printed circuit (FPC) is used to bridge the distance between the lenses and the electronics in the frame. The electro-optical components in the lens are usually connected to the FPC by direct soldering, but this does not result in a reliable connection, as the movable FPC can easily break the thin and fragile connection. This could happen due to shock, dropping, or even due to handling during assembly.

In the context of prescription glasses there is an additional challenge, as each pair of glasses needs to be personalized to each consumer. Not only the prescription (which determines the glasses curvature and edge thickness) but also the fitting (the position of the pupils specified as the distance between them and fitting height) is different for each customer. All these specs impacts the final thickness of the edged lenses and hence the position of the contacts.

As is clear from the above, there are a number of challenges when integrating an electronic device into an eyeglass frame. A first is that the frame must be adapted to accommodate the electronic device: this may lead to a frame that is suitable only for the integration of one particular electronic device, to undesirable bulkiness, and/or to an unappealing aesthetic result. A second challenge is to ensure a robust electrical connection between the control electronics and the electro-optical component(s) in the lens(es)—in particular, as discussed above, in the context of prescription glasses where the position of contact points in/on the lens(es) may vary from user to user. A third challenge is that the electronic device is preferably protected against moisture intrusion, yet at the same time it may be advantageous to be able to replace or access the electronic device. It is an object of the present disclosure to address at least some of these challenges.

Document US 2020/0225511 A1 discloses a pair of glasses comprising a frame with an upper rim portion into which an electro-active lens may be mounted. In one of the examples described in this document a gasket is provided around the radial circumference of the electro-active lens that is attached to the frame. The gasket is made of compliant, electrically insulating material. To enable electrical connectivity to the electro-active lens, apertures are provided in the gasket that accommodates a physically compliant conductive material, formed to mate with the gasket. However, the conductors are arranged outside the gasket, only at the positions of the apertures the conductors are capable of reaching the physically compliant conductive material. Therefore the glasses are still not adequately protected against intrusion of moisture.

According to embodiments of the present disclosure, a connector is provided suitable for providing an electrical connection between a control unit and at least one electro-optical component arranged in an electroactive lens for electronic glasses, in particular for electronic glasses wherein the electroactive lens has a circumferential rim along which a plurality of exposed contact areas are arranged providing electrical contact with the electro-optical component. The connector also includes a flexible cable, preferably comprising a flexible printed circuit (PCB), wherein the flexible cable is configured to be connected to and/or forms at least a part of the control unit and comprises connection portions to connect to a compressible connector module. At least one compressible connector module is configured to be positioned between the circumferential rim of the lens and the flexible cable, and is configured to provide an electrical connection between the plurality of exposed contacts and the connection portions of the flexible cable. When the flexible cable is placed in a frame of the electronic glasses and on the circumferential rim of the electroactive lens, the compressible connector is configured to be compressed between the lens and the frame. A sealing unit is also provided, configured to enclose at least the conductive portions of the flexible cable and the compressible connector module when the connector is placed on the lens.

The use of flexible cables—usually comprising or consisting of an FPC—with connection portions is not uncommon in the field. However, generally the electrical connection between the connection portions and the electro-optical component(s) in the lens is a fixed one, for instance provided using direct soldiering, which may be vulnerable to movement and/or deformation of the flexible cable, as well as easily affected by abrupt movements. Additionally, such a connection can be difficult to properly protect from moisture.

A compressible connector module, however, may at least partially address both these issues. Firstly, the fact that the connector module is compressible means that it is more resilient to shock. While the compressible connector module may be embodied in various ways—which will be discussed in more detail below—it is configured such that it ensures a robust electrical connection even when forces are applied to it. Furthermore, since the compressible connector is compressed between the lens and the frame when the flexible cable is placed in a frame of the electronic glasses and on the circumferential rim of the electroactive lens, the space between the flexible cable and the circumferential rim of the electroactive lens may be completely filled, which may already offer a certain level of moisture-protection, and may additionally may minimize the contact of the exposed contact areas with oxygen, thus avoiding/minimizing oxidation. Finally, the use of a compressible connector module rather than fixed contacts such as those achieved by direct soldiering means that in certain embodiments, a robust electrical connection may be established without requiring very precise positioning of the connector, making it possible to use a same connector for electronic glasses with differing positions of the exposed contact areas.

In some embodiments, the size and shape of the compressible connector module are such that it is able to simultaneously cover all contact areas of the plurality of exposed contact areas. This may increase robustness of the module and of the connector as a whole, and may also make it possible to achieve the desired moisture resistance with a fairly simple sealing unit.

Preferably the compressible connector module is resilient, in the sense that it tends to recoil or spring back when it is compressed. This may ensure that when positioned between the frame and the lens, it will occupy the maximum possible amount of space, which may prevent moisture from entering the space between the lens and the frame, specifically the space between the exposed contact areas on the circumferential rim of the lens and the connection portions on the flexible cable. This may for instance be achieved by the compressible connector module being at least partly made of resilient material and/or elastomeric material.

Preferably, the compressible connector module is configured to provide electrical conductance between connection portions of the flexible cable and respective exposed contact areas of the electroactive lens in the thickness direction of the connector module and provide electrical insulation in a lateral plane perpendicular to the thickness direction. The ‘thickness direction’ here, which may also be referred to as the z-direction, is the direction in which the various elements are stacked; this is the direction that, when the connector is positioned on the lens, is the normal direction to the circumferential rim of the lens—note that this direction is therefore not constant throughout the electronic glasses. The thickness or z-direction is also generally perpendicular to the surface of the flexible cable, which surface may be described as an x-y plane.

Having such a compressible connector module which is conductive only in the z-direction may ensure that each connection portion of the flexible cable is electrically connected to an associated one of the exposed contact areas—and preferably that each connection portion is electrically insulated from all the other ones of the exposed contact areas. This is because in most situations, it is undesirable to have ‘cross-talk’ between a connection portion of the flexible cable and any of the exposed contact areas of the electroactive lens which it is not expressly electrically connected to. In other embodiments, however, for instance embodiments wherein for each contact area of the lens edge at least one separate compressible connector module is used and wherein the compressible connector modules have been electrically insulated relative to each other).

Furthermore, in such embodiments, it is sufficient to position the flexible cable such that the connection portions thereof are separated from the respective exposed contact areas only in the z-direction, i.e. that they are positioned directly over/above the respective exposed contact areas to achieve the electrical connection. The exact positioning of the compressive connector module, on the other hand, is less relevant, as long as a portion of the compressive connector module is present between each contact area/connection portion pair.

These conductive properties may be achieved, for instance, by using a compressible connector module comprising alternating conductive and insulating regions in a rubber or elastomer matrix—elastomeric compressible connectors of this type are commercially available under the ZEBRA® name.

However, other embodiments are also possible. For instance, the compressible connector module could comprise a plurality of compressible connectors, preferably at least one compressible connector for each contact area of the plurality of exposed contact areas. In that case, the insulation between the contact area/connection portion pairs may be provided by the sealing unit, or by another insulating element provided between the different connectors. It is also possible to combine the two above-described options, i.e. for the compressible connector module to comprise a plurality of compressible connectors, of which any or all can be configured to be conductive only in the z-direction; for instance, a plurality of ZEBRA® elastomeric connectors could be used.

Alternately (or additionally) the compressive connector module may comprise a surface mount device, SMD, for instance an SMD having a silicone rubber core covered with a conductive film. For instance, a SMD type W, manufactured by MTC Micro Tech Components GmbH, could be used.

In embodiments, the compressible connector is configured to be compressed in thickness direction over 0.2 mm-5 mm, preferably 0.5. mm-2.5 mm, when the flexible cable is placed in the frame of the electronic glasses. Different compression tolerances, as well as optionally different resiliencies, may be desired depending on the application, the chosen frame, the desired level of moisture resistance, etc.

While the compressible connector module may be configured to provide the electrical connection between the plurality of exposed contact areas and the connection portions of the flexible cable by being in direct contact with the exposed contact areas, it may be advantageous for the connector to additionally comprise at least one connection element configured to be arranged directly onto at least one of the plurality of exposed contact areas, wherein the connection element is at least partially electrically conductive. This at least one connection element is positioned between the exposed contact areas and the compressible connector module, to electrically connect the exposed contact areas to the compressible connector module.

The at least one connection element may be provided in several ways. As an example, it may comprise electrically conductive adhesive material to be applied to one or more of the exposed contact areas of the electroactive lens, for instance Ag glue. This electrically conductive adhesive material may be configured to be applied as one or more layers on top of an exposed contact area on the circumferential rim of the lens.

Alternately or additionally, the connection element may comprise a conductive tape to be applied to one or more of the exposed contact areas of the electroactive lens.

The conductive element, in particular if it is formed using conductive tape or if it is otherwise formed as a layer, may only be conductive in certain areas, for instance comprising a plurality of conductive areas each configured to cover one contact area of the plurality of contact areas. Alternately or additionally, the connection element may be configured to be electrically conductive only in the z-direction, i.e. along the direction perpendicular to its surface. To achieve the desired conductive properties, the connection element may comprise conductive particles which allow electrical interconnection between connection portions of the flexible cable and exposed contact areas of the electroactive lens in the thickness direction, wherein these particles are spaced far enough apart for the connection part to be electrically insulating in the plane of connection part.

The connector may additionally comprise at least one further connection element arranged between the connection element described above and the compressible connector module. This further connection element may for instance comprise a flexible printed circuit (FPC). In other embodiments, the connection element may itself comprise a flexible printed circuit, in which case a further connection element may not be required.

As discussed, it is highly desirable for the electronic elements, including the parts ensuring the electrical connection between the control unit and the electro-optical component(s) in the electroactive lens(es), to be protected against moisture. This compressible connector module plays a role in achieving this, as described above. The sealing unit configured to enclose at least the connection portions of the flexible cable and the compressible connector module further helps achieve this goal.

The details of the sealing unit of course depend on the particulars of the compressible connector module and of the other elements of the connector. In embodiments, it at least comprises a flexible housing, wherein when the connector is placed on the lens, the flexible housing forms, with the lens, a waterproof enclosure for at least the connection portions of the flexible cable, the compressible connector module, the exposed contact areas, and, optionally, also for a further portion of the flexible cable and/or for at least part of the connection element or elements, if present. The flexible housing preferably comprises resilient material, for instance silicone. Preferably, it is made of resilient material.

The flexible housing may consist of multiple parts. For instance, it may comprise a first housing element for accommodating at least the at least one compressible connector module and a second housing element configured to be placed over the second housing element and the at least one compressible connector module accommodated therein. The second housing element is configured to further accommodate at least the connections portions of the flexible cable. The second (or optionally first) housing element may also accommodate the other connection element or elements, if present. In these embodiments, the material properties of the first and second housing may be the same, but could advantageously also be different. For instance, it may be desirable for the first housing to be sturdier, i.e. somewhat less compressible, than the second housing.

The first housing element may for instance take the form of a gasket, which may be provided pre-assembled with the compressible connector module. This may in particular be advantageous in embodiments wherein the compressible connector module comprises more than one compressible connector—the first housing may then, aside from providing protection against moisture, serve to hold the compressible connectors in place at a certain distance from each other, and may in some embodiments also be configured to electrically insulate the compressible connectors from each other. The use of a gasket-like first housing element may also be advantageous for other embodiments.

Aside from providing protection against moisture, the sealing unit may be configured to electrically insulate the plurality of exposed contact areas from each other.

The protection from moisture is preferably achieved by configuring the sealing unit to seal the compressible connector module, the exposed contact areas, and the connection portions of the flexible cable from the environment, as well as optionally at least part of the connection element or elements, if present.

Exemplifying embodiments further relate to electronic glasses comprising a connector as described above. In particular, the electronic glasses comprise a frame, at least one electro-active lens comprising an electro-optical element and a plurality of exposed contact areas along a circumferential rim of the lens, each contact area comprising a contact terminal in connection with the electro-optical element; a control unit for controlling the electro-optical element of the at least one electro-active lens; and a connector as described above. The connector is positioned to provide an electronic connection between the control unit and the electro-optical element of the at least one electro-active lens. In embodiments of the present disclosure the contact terminals may be embodied as screen-printed conductive lines, for instance Ag-lines or lines made of transparent material, connecting the contact areas with a respective one of the transparent electrodes of the electroactive lens.

Preferably, the connector is positioned such that the flexible cable is placed in and/or along the frame, and the compressible connector module is compressed between the lens and the frame. The compressible connector module may be applied directly to the plurality of exposed contact areas, or a connection element of the connector may be applied directly to the plurality of exposed contact areas. In the latter case, this connection element will be positioned between the compressible connector module and the lens, and may in fact be kept in place by the compressible connector module, without requiring any additional attachment means. In such embodiments, it may be possible to replace the connector, or elements thereof.

In certain embodiments, the at least one electroactive lens is arranged for a tuneable transmission of light.

In a preferred embodiment, for which the described connector may be particularly advantageous, the at least one electroactive lens comprises: a first and a second optically transparent substrate, wherein the first and second optically transparent substrates extend generally parallel to each other; a first optically transparent electrode formed on the first optically transparent substrate and a second optically transparent electrode formed on the second optically transparent substrate; a diffractive lens structure, such as a Fresnel lens structure, connected to the second optically transparent electrode; and a sealed cavity between the first and second optically transparent electrodes, wherein in the sealed cavity at least an LC layer of liquid crystalline (LC) material (preferably—but not limited to—nematic liquid crystalline material) is arranged and wherein liquid crystals in the liquid crystalline (LC) material are generally axially aligned. The control unit is then be configured to change the optical power of the electroactive lens by applying a voltage to the first and/or second optically transparent electrode thereby altering the refractive index of the LC layer in the transverse direction. In such embodiments, the plurality of contact areas may be exposed areas of the first and second optically transparent electrodes.

There are various ways in which the plurality of exposed contact areas providing electrical contact with the electro-optical component(s) along the circumferential rim of the electroactive lens(es) may be provided. Preferably, the at least one electroactive lens comprises a circumferential bevelled edge into which the first and second optically transparent electrodes extend (or at least conductive lines may extend into the bevelled edge, the conductive lines being connected with the respective transparent conductive layers, for instance indium tin-oxide (ITO) layers, of the electroactive lens) and wherein exposed contact areas are formed by removing one or more portions of the bevelled edge. The portions may be removed radially inward, thus providing one or more essentially flat exposed contact areas. Alternatively or additionally, the portions may be removed axially inward, for instance by drilling one or more recesses or openings in one or more of the sides of the bevelled edge. To increase the area or otherwise make it easier to connect to the contact areas, conductive glue may also be used, for instance Ag glue.

The electronic glasses may further comprise a clamping mechanism in the frame configured to apply a mechanical force between the flexible cable and the compressive connector module. However, other mechanisms may also be employed to attach the frame and the compressible connector module, preferably in a releasable manner.

Further details, advantages and characteristics of the present disclosure are apparent from the following description of several exemplifying embodiments thereof. In the description reference is made to the annexed drawings, wherein:

FIG. 1 shows an embodiment of electronic glasses for which the claimed connector may be suitable;

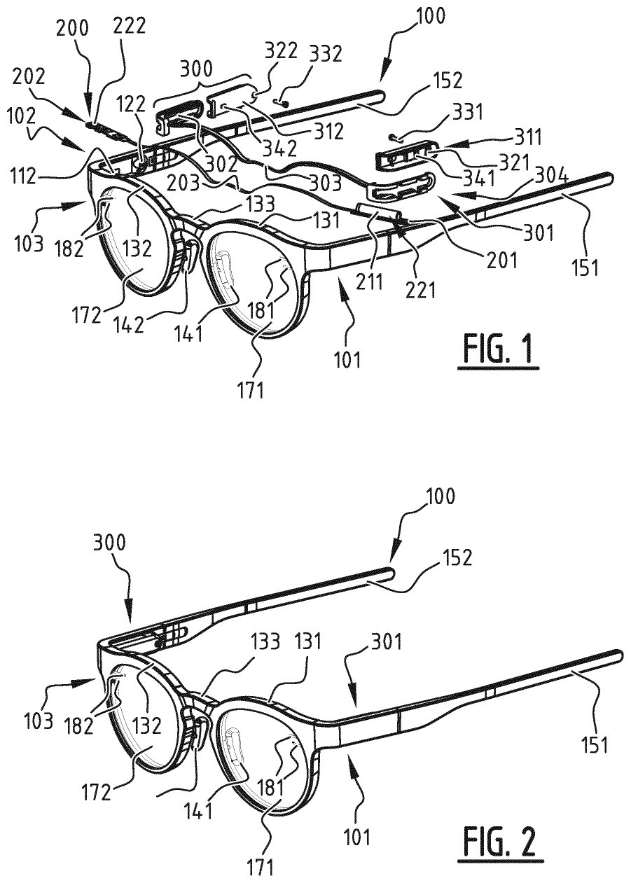

FIG. 2 shows the embodiment of FIG. 1 in its assembled state;

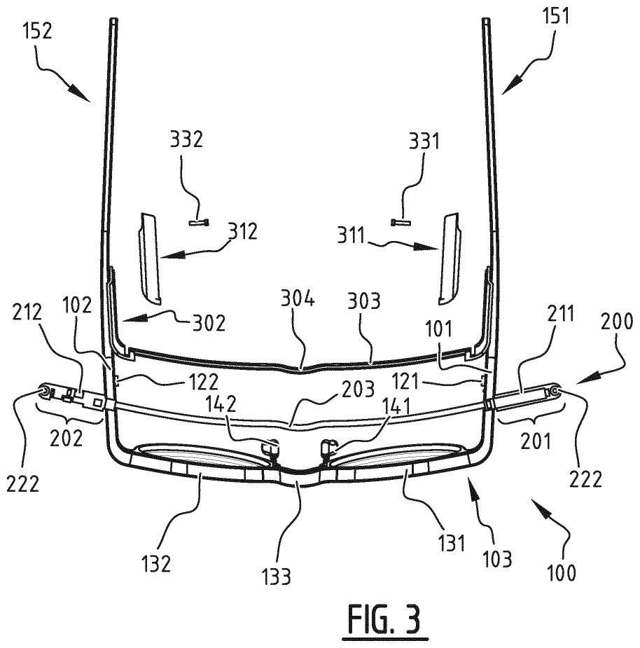

FIG. 3 shows a top view of the disassembled embodiment shown in FIG. 1;

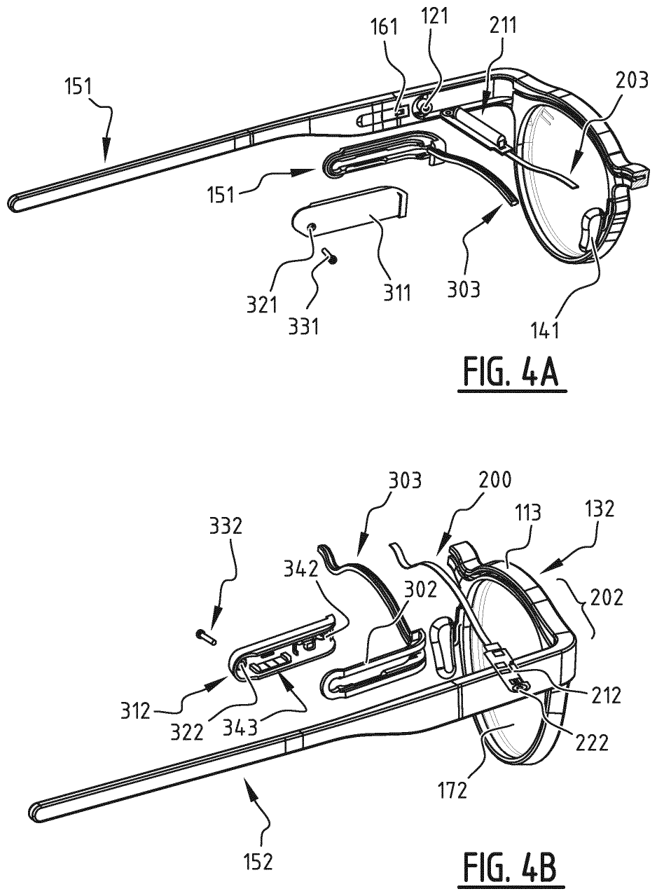

FIG. 4A and FIG. 4B are detail views from different perspectives of the disassembled embodiment of FIGS. 1 and 3;

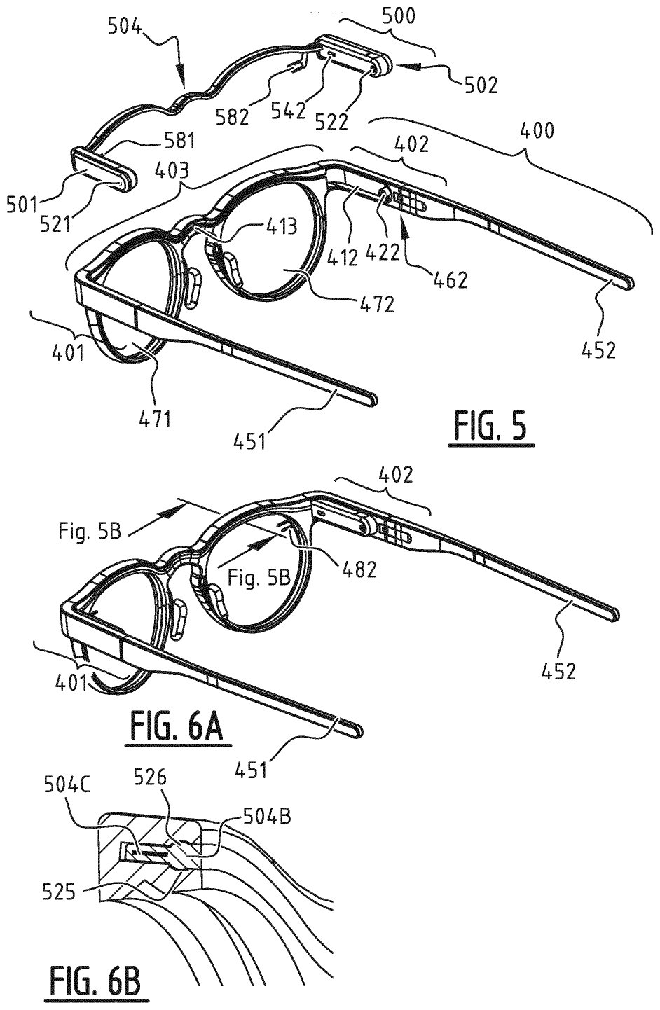

FIG. 5 is a perspective view of another embodiment of electronic glasses, using an alternate connector than the connector according to embodiments of the present disclosure, in a disassembled state;

FIG. 6A shows the embodiment of FIG. 5 in its assembled state;

FIG. 6B shows a cross-cut detail of FIG. 6A along the line A-A indicated in that figure;

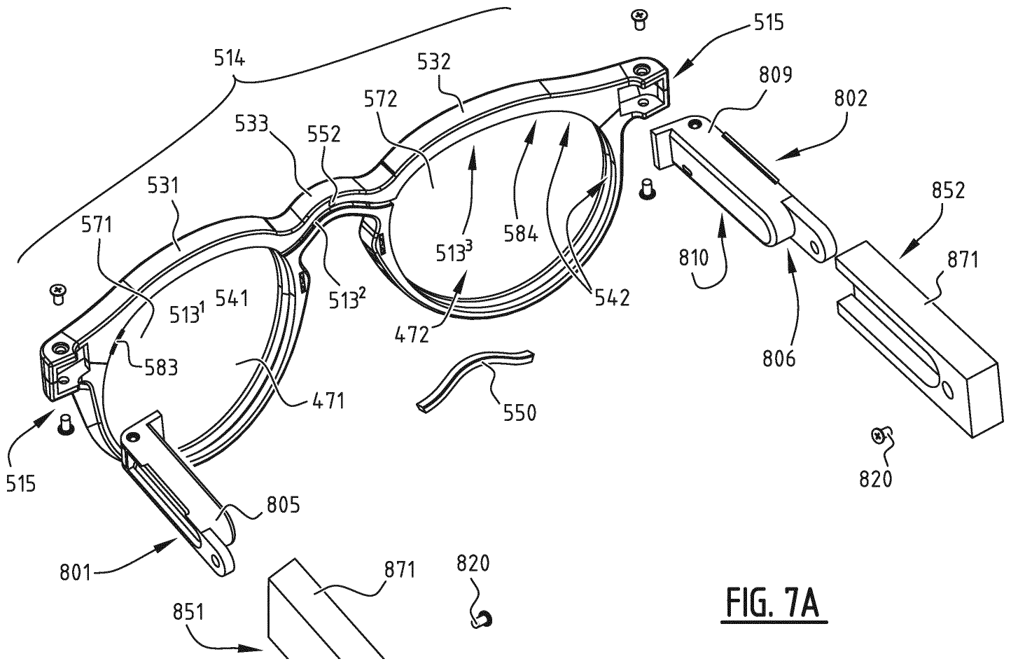

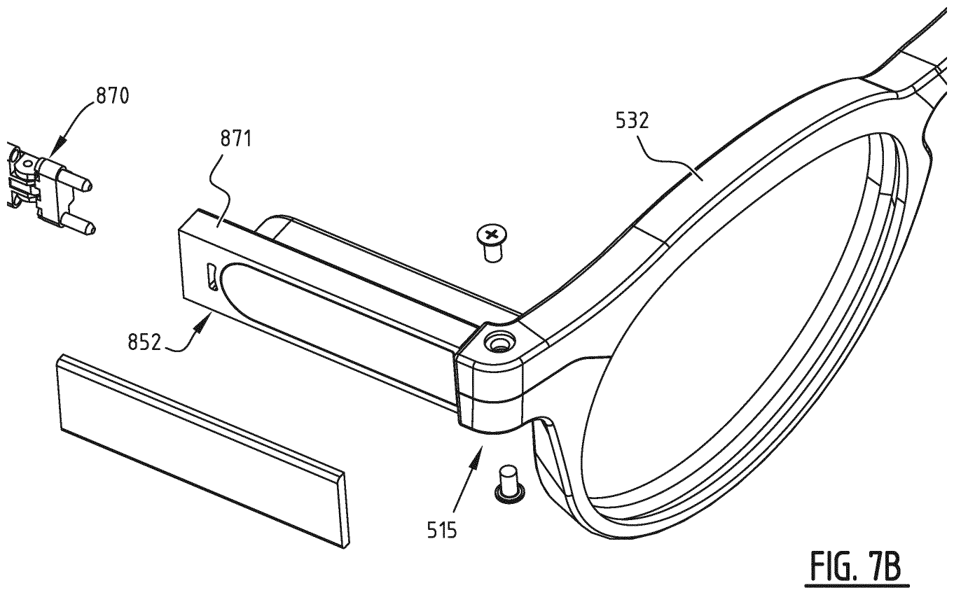

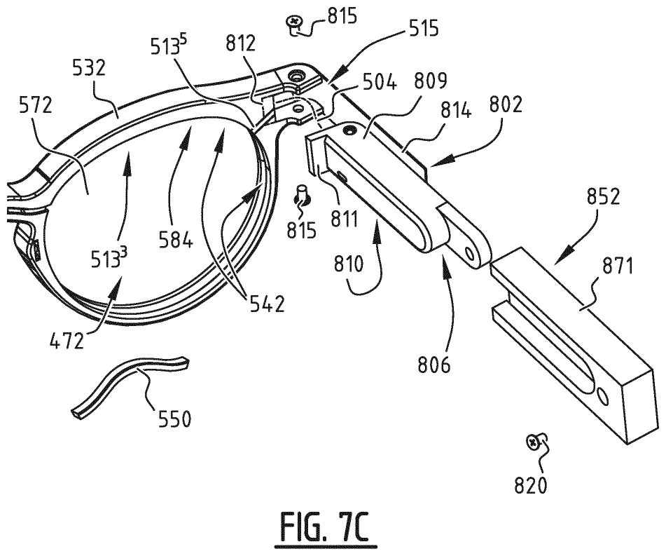

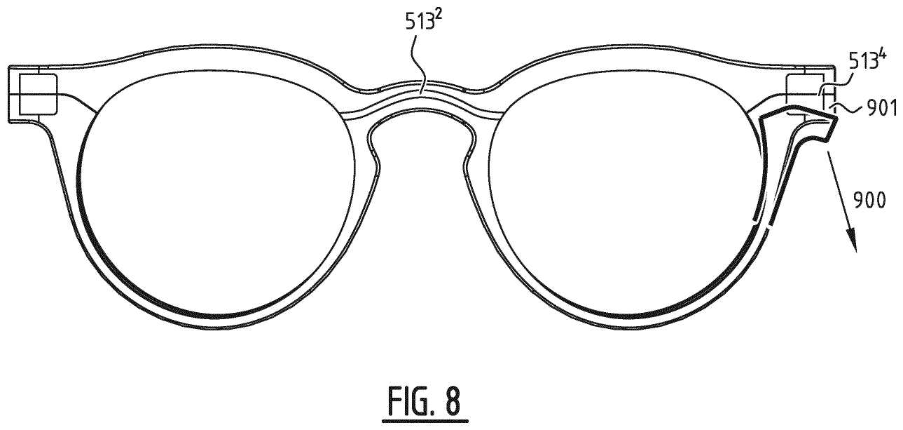

FIGS. 7A and 7B show an embodiment of electronic glasses according to the present disclosure, while FIG. 8 is a detail back side view of a part of the groove that is configured to be widened;

FIG. 7C shows an embodiment similar to the embodiment of FIGS. 7A and 7B, with a additional groove parts, cavities for receiving respective hook-shaped ends of the temple parts and a housing cover integrally formed with the front part of the glasses/spectacles;

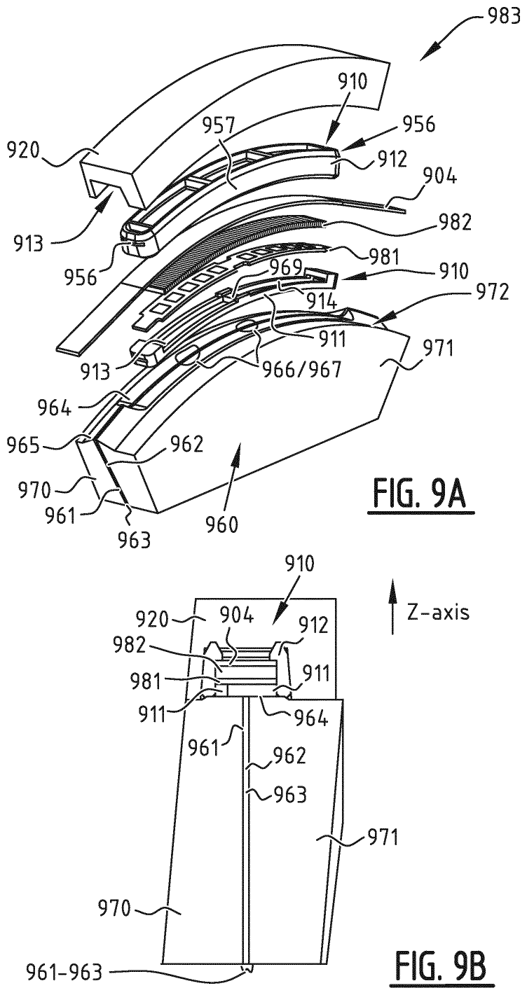

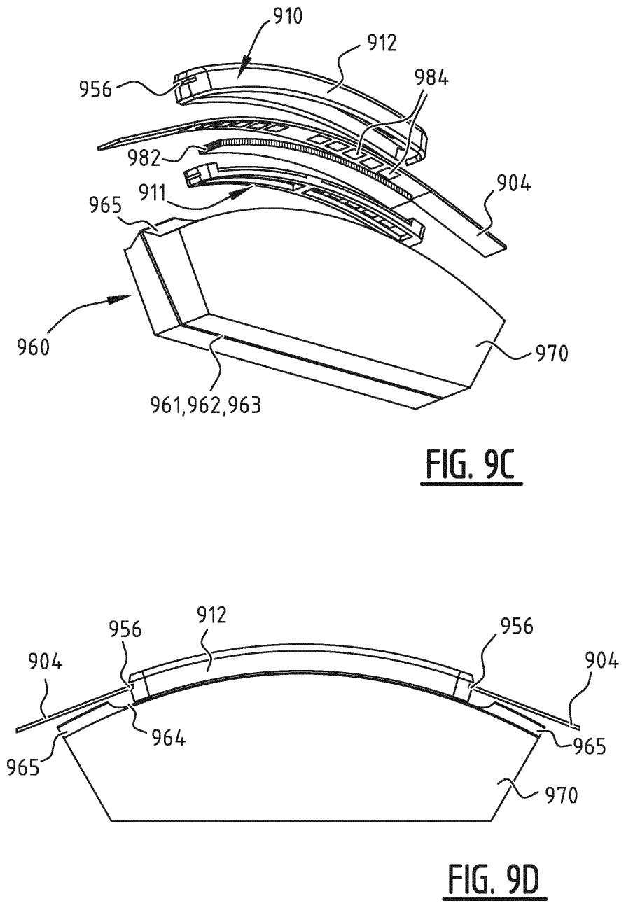

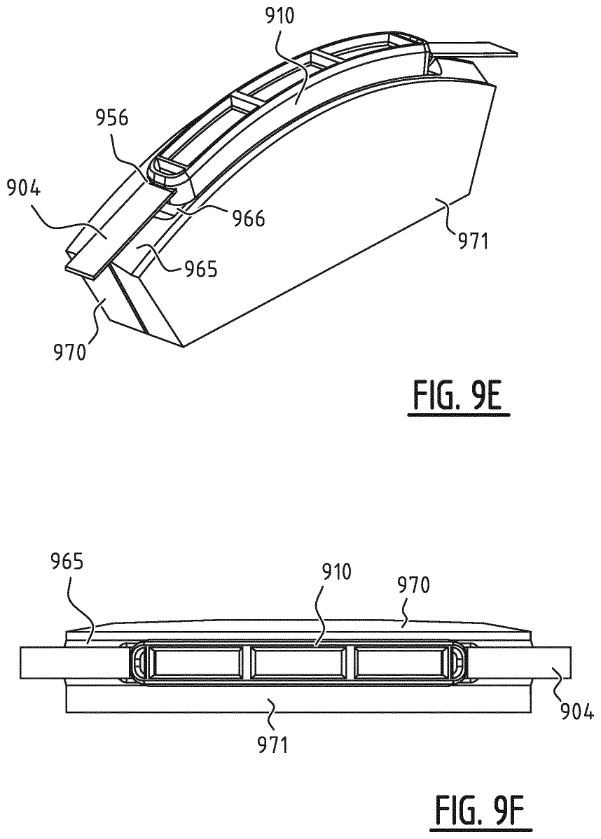

FIG. 9A-9F show various views of an embodiment of a connector according to embodiments of the present disclosure, together with a part of a lens: FIGS. 9A and 9C show this embodiment in a disassembled state, from different angles; FIG. 9B shows a cross-section in a plane perpendicular to the circumferential rim of the lens; and FIG. 9D-9F show this embodiment in its assembled state from different viewpoints, respectively a side view, a perspective view, and a top view;

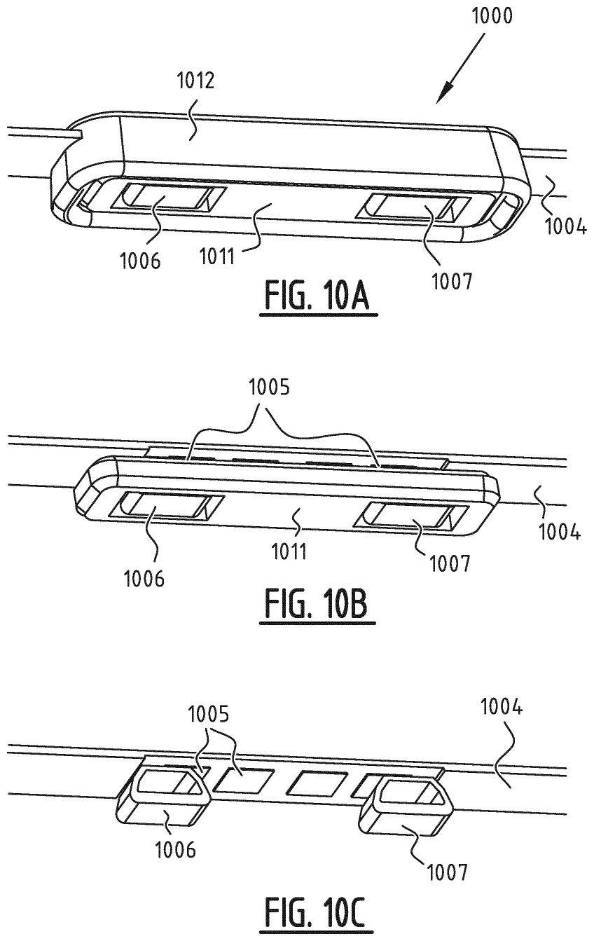

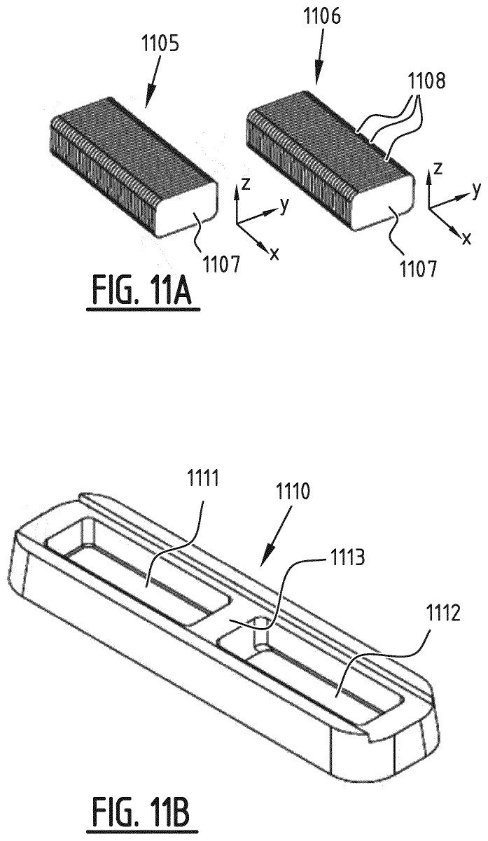

FIG. 10A-10C show another embodiment of a connector according to embodiments of the disclosure at various stages of assembly, wherein FIG. 10A shows the full connector;

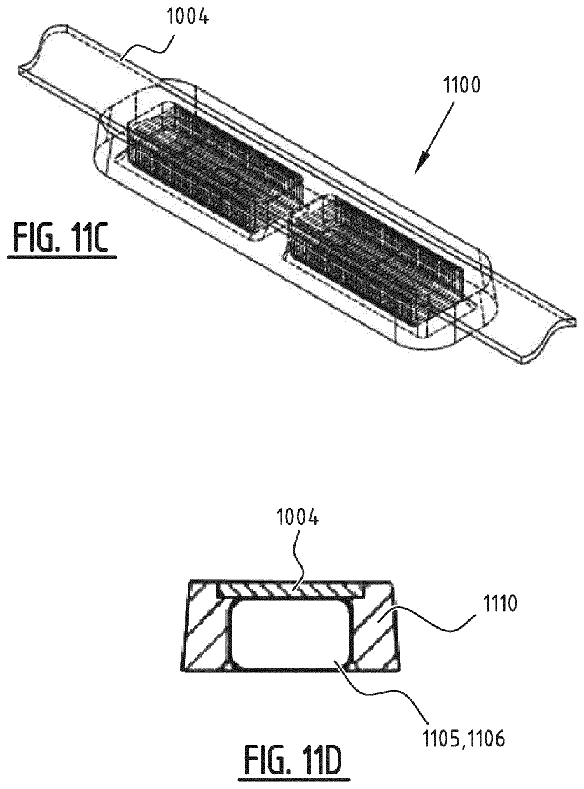

FIG. 11A-11D show yet another embodiment of a connector according to embodiments of the disclosure, wherein FIG. 11A shows two compressible connectors, FIG. 11B shows a gasket/housing forming part of the sealing unit, FIG. 11C shows the elements depicted in FIGS. 11A and 11B assembled with a flexible printed circuit in a perspective view, and FIG. 11D is a cross-section of the assembled connector shown in FIG. 11C;

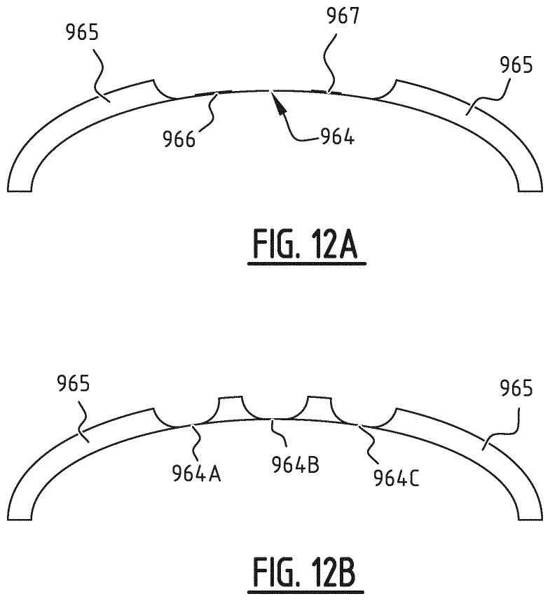

FIGS. 12A and 12B show two possible ways an electroactive lens of electronic glasses may be adapted to provide exposed contact areas for which embodiments of the connector according to embodiments of the disclosure may be suitable;

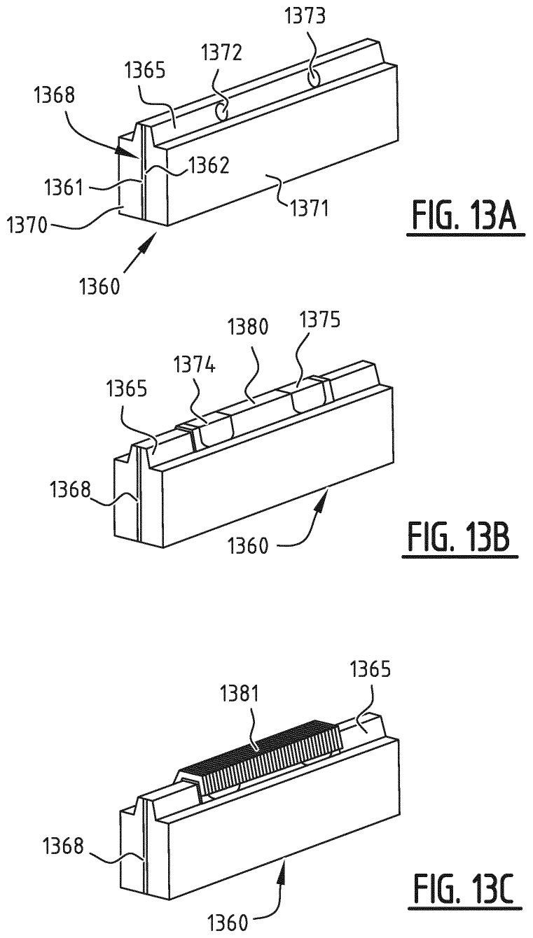

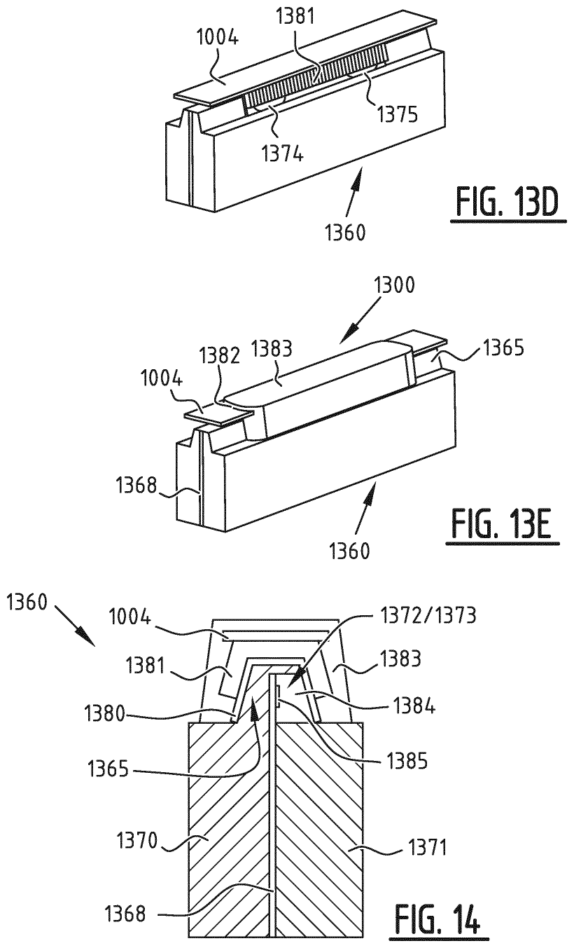

FIG. 13A-13E relate to yet another embodiment of a connector and electronic glasses according to embodiments of the disclosure, in various stages of assembly: FIG. 13A shows a section of an electro-active lens configured to have exposed contact areas; FIG. 13B shows this lens and a connection element arranged on the lens; FIG. 13C additionally shows a compressible connector module arranged on the connection element; FIG. 13D additionally shows the flexible cable; and FIG. 13E additionally shows the sealing unit;

FIG. 14 shows a cross-section of the embodiment of FIG. 13A-13E, over a plane perpendicular to the circumferential rim of the lens.

In the following description, for the purposes of explanation, numerous specific details are set forth in order to provide a thorough understanding of the exemplifying embodiments of the present disclosure. It will be apparent, however, that the concept of the present disclosure may be practiced without these specific details. In other instances, well-known structures and devices are not described in exhaustive detail, in order to avoid unnecessarily obscuring the present disclosure.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein. Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

As will be apparent to those of skill in the art upon reading this disclosure, each of the individual embodiments described and illustrated herein has discrete components and features which may be readily separated from or combined with the features of any of the other several embodiments without departing from the scope of the present disclosure. Any recited method can be carried out in the order of events recited or in any other order which is logically possible.

Electronic glasses according to exemplifying embodiments of the present disclosure may be manufactured using a method of integrating an electronic device into an eyeglass frame configured to provide with at least one electro-optical component as described below, though other methods may also be employed, and the connector may also be used in electronic devices that are not (or even could not) be manufactured using this method.

A method of integrating an electronic device into an eyeglass frame configured to be provided with at least one electro-optical component may comprise providing an eyeglass frame comprising a front part, a first temple and a second temple, wherein said temples each comprise a front temple part, of which one end is attached to a side of the front part, and a rear temple part, wherein the other ends of the front temple parts are attached to the respective rear temple parts so that the front temple parts and rear temple parts are movable with respect to each other, and wherein a first front temple part has a first cavity, a second front temple part has a second cavity and the front part has a groove extending between the first cavity of the first front temple part and the second cavity of the second temple part; providing an electronic device comprising a first device part, a second device part, a flexible cable configured to electrically connect the first device part and the second device part, and for each component being an electro-active component, a connector suitable for providing an electrical connection between the electronic device and the at least one electro-active component; providing closure means comprising a sealing element; and integrating the electronic device into the eyeglass frame, wherein the first device part is arranged at least partially in the first cavity, the second device part is arranged at least partially in the second cavity, and the flexible cable is arranged in the groove, wherein the closure means are arranged to ensure that the electronic device is enclosed in such a way that it is substantially protected from moisture intrusion or other contamination. The connector is advantageously a connector according to the present disclosure.

The electro-optical component may be (preferably) an electro-active lens, or an LED, VCSELS or similar component. The flexible cable is arranged in the groove, wherein the closure means are arranged to ensure that the electronic device is enclosed in such a way that it is substantially protected from moisture intrusion or other contamination.

The sealing element may be at least partially made of a flexible material. In this manner the shape of the sealing element can be adapted to correspond (at least to some extent) to the shape of the groove inside which the flexible cable is arranged. This makes it easier to seal of the groove with the flexible cable inside so that the cable is protected from moisture etc. The sealing element may be at least partially made of compressible material and/or elastic material. Elastic material is compressible but also has the tendency to return at least partially to its original shape once it has been compressed. For instance, the sealing element in this way can be easily attached to the front part of the eyeglass frame by clamping the sealing element into or onto the front part, for instance into the groove provided in the frame.

The first cavity of the first temple part may be in connection with one end of the groove and the second cavity in the second temple part is in connection with the opposite end of the groove. The method then may comprise arranging the flexible cable in the first cavity, in the groove and in the second cavity in order to provide an electrical connection between the first (electronic) device (to be) installed in the first cavity and the second (electronic) device (to be) installed in the second cavity.

The method may comprise the following steps. First, providing an eyeglass frame, an electronic device, and closure means. The eyeglass frames comprise a front part, a first temple and a second temple. Said temples each comprise a front temple part, of which one end is attached to a side of the front part, and a rear temple part. The other ends of the front temple parts are attached to the respective rear temple parts in such a way that the front temple parts and rear temple parts are movable with respect to each other, which allows the glasses to be foldable. The first front temple part is provided with a first cavity and the second front temple part is provided with a second cavity and the front part is provided with a groove running from the first cavity to the second cavity, preferably on the rear side. These cavities and this groove allow the frames to accommodate the electronics. The electronic device comprises a first device part, a second device part, and a flexible cable configured to provide an electrical connection between the first device part and the second device part. The closure means comprise a sealing element wherein the sealing element is preferably at least partially made of a flexible, compressible and/or elastic material. The method further comprises integrating the electronic device into the eyeglass frame, wherein the first device part is arranged at least partially in the first cavity, the second device part is arranged at least partially in the second cavity, and the flexible cable is arranged in the groove, wherein the closure means are arranged to ensure that the electronic device is enclosed in such a way that it is substantially protected from moisture intrusion or other contamination. In particular, it is desirable to protect the electronic device from any element which may impede its functioning or reduce its lifetime.

Note that in this description, the “front” side is the side with the front part, i.e. the side which, when the eyeglasses are worn by a user, is oriented forward; correspondingly, the “rear” side is opposite to that, such that the rear side of the front part is the side which, when the eyeglasses are worn by a user, is oriented towards the user's face. Note furthermore that potential other elements of the frame which are not of particular relevant to the disclosure, such as for instance nosepads, may also be included in the eyeglass frame.

The sealing element may comprise any suitable material to achieve a seal which allows for the protection from moisture intrusion or other contamination. Flexible materials may be suitable, for instance. A compressible material may be advantageous, and an elastic material may in particular be useful—however, other possibilities also exist, depending also on the choice of material or materials for the frame. The word “elastic” is not intended herein as restrictive: for the purposes of the application, any material which is at least somewhat compressible, and which, when the compressing forces are no longer present, returns at least in part—though not necessarily completely—to its initial shape and size, is an elastic material. Possible elastic materials include rubbers and certain silicones, such as elastomers. Note furthermore that to be able to achieve the desired protection from moisture intrusion or other contamination, the sealing element advantageously comprises a moisture-resistant or preferably water-impervious material.

Preferably, in the eyeglass frame, the first front temple part and the second front temple part, which are the parts which include the cavities, are fixedly connected on either side of the front part. In other words: these parts cannot move with respect to the front part. This means that the section of the eyeglass frame into which the electronics are integrated does not need to include hinges or other moving parts, and that in integrating the electronic device no specific (and often complex) arrangements need to be made to provide an electronic connection through a hinge. It is even possible to provide the front part, the first front temple part and the second front temple part as a single element, for instance manufacturing it by injection moulding, milling (including CNC milling), or 3D printing; however it is also possible to provide the section of the frame comprising the front part and the front temple parts by providing a plurality of elements, potentially including different materials, and fixedly connecting them, for instance by gluing, heating and pressing, or welding—the method may depend on the used materials, for example. These elements may, but need not, each correspond to one of the front part, the first front temple part and the second front temple part. Manufacturing the front part and the front temple parts as a single element may be more robust; using a plurality of elements may be preferable for instance with frames milled at least partially of acetate, for which it may be difficult and/or economical to manufacture larger elements, and/or if it is deemed desirable to use a different material for the front temple parts than for the front part.

The movable attaching of the front temple parts to the respective rear temple parts may be provided by hinged connections, as is quite common in the field of eyewear design, but the skilled person in this field will also be aware of alternate options, for instance those used for hingeless frames. Note that the temples may include other parts in addition to the rear and front temple parts.

An advantage of the method described here is that the eyeglass frame may be provided by modifying an existing eyeglass frame design to include the groove, the first cavity, and the second cavity. For instance, for frames made at least in part of injection moulded plastic, the (usually metal) mould may be adapted to include the groove and/or cavities. Acetate based frames are individually milled from acetate slabs and can thus easily be adapted to include the groove and cavities. For 3D printed materials, the original CAD-file may be adapted, and so on. The modifying of the existing eyeglass frame design may comprise adapting the shape and size of the front part and/or the front temple parts such that they can accommodate the groove and/or the cavities, respectively. In particular, many existing eyeglass frame designs have no or only a small and sometimes quite slim front temple part bending rearwards from the front part, and include a hinged or other movable connection quite close to the rear side of the front part. Therefore, in modifying existing designs, it may be necessary to add front temple parts of sufficient size to accommodate the cavities, with a corresponding adaptation of the rear temple parts; or to lengthen, broaden and/or heighten existing front temple parts to be able to accommodate the cavities, with a corresponding adaptation of the rear temple parts. Advantageously, such modifications result in a frame wherein any hinge or other element allowing for respective movement of the front and rear temple parts is located behind, i.e. more towards the rear, the integrated electronics, which may improve the robustness and lifespan of the electronics, and/or which may allow for simpler frame/glasses design.

The groove may, depending on the specifics of the electronic device and in particular the flexible cable, be quite small, and therefore quite a few existing frame fronts may be able to accommodate it without requiring further modification. For instance, the groove may have a depth of between 1 and 5 mm, preferably between 3 and 4 mm, and a height of between 0.7 and 1.5 mm, preferably between 0.9 and 1.2 mm; note furthermore that it may be advantageous for the height of the groove to vary along its depth, for instance to improve the seal and/or to be able to firmly lodge the sealing element in the grove, which could be done by providing the groove with a recessed section as will be explained in more detail with respect to the figures. In other existing designs it may be necessary to modify the front part to be able to accommodate the groove.

Regardless of whether the eyeglass frame is a new design or a modified version of an existing design, note that it is desirable to adapt the size and shape of the first cavity, the second cavity and the groove to the size and shape of the electronic device and the closure means. Advantageously, both the cavities and groove and the electronic device will be designed to be as small as possible, so as to reduce bulk in the resulting glasses; it may furthermore be advantageous to standardize the size of the cavities and groove, such that a same electronic device may be integrated into different frame designs.

The first front temple part and/or the second front temple part of the frame provided in the method may comprise fastening elements configured to cooperate with the electronic device and/or the closure means in the step of integrating the electronic device into the eyeglass frame, for instance by cooperating with corresponding fastening elements included in the electronic device and/or the closure means. The fastening elements may, as described in more detail with respect to the illustrated embodiments, comprise a threaded opening, with the electronic device and/or the closure means then having an aperture such that they may be fastened to the temple parts by a correspondingly threaded screw. However, the skilled person will be aware of many possible fastening elements, including but not limited to fastening elements involving a screw or other threaded connection, snap/click fastening elements, clipping means, and adhesive.

Note that the providing of the frame may, but does not necessarily involve, the manufacturing of the eyeglass frame, for instance the manufacturing of at least parts of the frame by injection moulding, milling, and/or 3D printing. It may also include the providing of all parts of the eyeglass frame and the assembling of these parts into an eyeglass frame; or the providing of some parts of the eyeglass frame and the manufacturing of other parts of the eyeglass frame.

The method outlined above may be particularly suitable for integrating an electronic device suitable for the control of at least one electro-active lens into an eyeglass frame, for instance to manufacture the electronic glasses according to the disclosure. The method then includes fitted lenses in eyepieces included in the front of the eyeglass frame, wherein at least one of the lenses comprises an electro-active lens system. Such lenses may for instance be lenses for active 3D glasses, or electro-optical glasses with adjustable focus. To control such lenses, they must have an electrical connection to an electronic device.

To accommodate such a connection, the method therefore may include providing an eyeglass frame wherein, for each lens comprising an electro-active lens system, a passage and/or groove may be provided from the cavity of the first and the second cavity which is closest to this lens, to an edge of the lens—specifically, to the exposed contact areas on the circumferential edge of the lens. The integrating of the electronic device into the eyeglass frame using the closure means then includes, for each lens comprising an electro-active lens system, establishing an electrical connection between the electronic device and the at least one electro-active lens system through the passage and/or groove. For instance, the electronic device may include, for each electro-active lens system, a connector suitable for providing an electrical connection between the electronic device and the electro-active lens system, and the electrical connection may be established by arranging this connector through the passage such that it contacts the electro-active lens system; for instance, this connector may contact the aforementioned connection point (i.e. an exposed contact area), or may be inserted partway into the lens in order to establish a connection.

In the electronic device, one of the first device part and the second device part may comprise a power supply device, and the other of the first device part and the second device part may comprise a printed circuit board (PCB). However, other arrangements are also possible.

The closure means provided in the method may comprise at least one interface element, wherein the interface element is preferably an element configured to allow a user to input a command for the electronic device; to output information from the electronic device to a user; or to allow power transfer to the electronic device. In existing electronic glasses, such interface elements are often integrated in the frame. However, since the proposed method uses closure means in the integrating of the electronic device into the frame, it may be advantageous to incorporate such interface elements in these closure means, instead. In particular, this may make it possible to integrate slightly different (but similarly sized) electronic devices into a given eyeglass frame design, without needing to further modify or adapt this design, by adapting the closure means. This may also make it possible to adapt the integration to a user's preferences: for instance, a right-handed user may prefer to have input means located on the right side of electronic glasses, while a left-handed user may prefer to have input means located on the left side of electronic glasses; the method may, by providing appropriate closure means (together with a suitable electronic device), be used with a same eyeglass frame design to suit either type of user.

As mentioned previously, the electronic device should be sufficiently protected from moisture intrusion or other contamination. To this end, the sealing element of the closure means provided in the method may comprise a compressible and/or elastic front section configured to fit into and/or over the groove such as to define, with the groove, a channel configured to be able to accommodate the flexible cable of the electronic device.

Providing the closure means may further comprise providing a first lid and a second lid, wherein the first lid is configured as a cover for the first cavity in the first temple and the second lid is configured as a cover for the second cavity in the second temple; and providing sealing material between each of the said lid and said corresponding front temple parts to render the cavity protected from moisture intrusion or other contamination, said sealing material being optionally part of or attached to the sealing element covering the groove.

The sealing material may for instance be embodied as a first compressible and/or elastic ring and a second compressible and/or elastic ring which first ring is configured to provide a seal between the first lid and the first cavity, and which second ring is configured to provide a seal between the second lid and the second cavity. The integration step of the method preferably then comprises the following steps. For the electronic device: arranging the first device part at least partly in the first cavity, arranging the second device part at least partly in the second cavity, and arranging the flexible cable into the groove. For the sealing element of the closure means: arranging it such that the compressible and/or elastic front section seals the flexible cable into the groove, thus substantially protecting the flexible cable from moisture intrusion; the first ring is arranged around an edge of the first cavity; and the second ring is arranged around an edge of the second cavity. Finally, for the lids: arranging and fastening the first lid on the first cavity such that the first ring provides a seal between the first lid and the first cavity, thus substantially enclosing the first device part and protecting it from moisture intrusion; arranging and fastening the second lid on the second cavity such that the second ring provides a seal between the second lid and the second cavity, thus substantially enclosing the second device part and protecting it from moisture intrusion. For instance, as will be described in more detail with respect to a specific embodiment, a screw can be used to fasten each lid in a corresponding threaded opening in the respective cavity, tightly pressing the ring between the lid and an edge of the respective cavity, wherein this screw preferably also passes through a hole provided in the respective device part; however, other attachment means are also possible, for instance a snap-fit connection or even a moisture resistant adhesive. However, note that non-permanent connection methods are preferred, due to the desirability of accessing and potentially repairing and/or replacing the electronic device without needing to replace the eyeglasses as a whole.

It may also be desirable to assemble the electronic device and the closure means prior to the integration in the eyeglass frame. In such cases, the method comprises a step of assembling at least part of the closure means and the electronic device to form a sub-assembly, wherein preferably the electronic device is substantially protected from moisture intrusion or other contamination in the sub-assembly; followed by a step of fastening the sub-assembly to the eyeglass frames. This may be achieved for instance by the closure means comprising a first housing and a second housing, with the assembling the sub-assembly then comprising arranging the first housing around the first device part, such as to substantially enclose the first device part; and arranging the second housing around the second device part, such as to substantially enclose the second device part. Additionally or alternately, the method may then also includes encapsulating the flexible cable with a compressible and/or elastic material. This may be performed before, after, or simultaneously to the arranging of the first and second housings around the respective device parts. By doing this, it is not necessary to first arrange the flexible cable in the groove and to then seal the groove with a separately provided sealing element: instead, it is sufficient to arrange the encapsulated cable into the groove. Note that the compressible and preferably elastic material encapsulating the cable may in this case be seen as the sealing element of the closure means.

The flexible cable of the electronic device may be a simple cable, but it may also comprise a flexible PCB. For instance, the flexible cable may be a flexible printed circuit (FPC) cable. This may make it possible to minimize the size of the first and second device parts. Since such a flexible PCB may be more vulnerable than a simple cable, it is recommended to encapsulate it with a compressible and preferably elastic material, as described above, prior to arranging it in the groove.

To manufacture electronic glasses according to the exemplifying embodiments of the present disclosure, a method of manufacturing an electronic pre-assembly may also be employed. This method comprises providing an electronic device comprising a first device part, a second device part, and a flexible cable, preferably a flexible printed circuit board (PCB), configured to provide an electrical connection between the first device part and the second device part; manufacturing a first housing and a second housing, wherein the first housing is shaped to fit at least partially in the first cavity and configured to enclose the first device part; and wherein the second housing is shaped to fit at least partially in the second cavity and configured to enclose the second device part; arranging and sealing the first housing to enclose the first device part; and arranging and sealing the second housing to enclose the second device part.

Preferably, the method also comprises encapsulating the flexible cable by a compressible and/or elastic material such that the electronic device as a whole is substantially protected from moisture intrusion or other contamination.

The method may also be used to manufacture an electronic pre-assembly for integration into an eyeglass frame fitted with at least one electro-active lens system. It then comprises providing at least one connector suitable for providing an electrical connection between the electronic device and an electro-active lens system. This connector is preferably a connector as described herein.

The frame of the electronic glasses according to exemplifying embodiments of the present disclosure may be manufactured according to the following method, which may be of use with an electronic pre-assembly described above. The method comprises manufacturing a first front temple part with a first cavity; manufacturing a second front temple part with a second cavity; and manufacturing a front part with a groove, preferably on the rear side, wherein when the first front temple part and second front temple part are arranged on either side of the front part, the groove runs from the first cavity to the second cavity. The method further comprises manufacturing a first real temple part and a second rear temple part, configured to be attached to the first front temple part and second front temple part, respectively, in such a way that the front temple parts and rear temple parts are movable with respect to each other, preferably by a hinged connection. The first front temple part, the second front temple part, and the front part may be manufactured as a single piece, preferably by injection moulding, milling, or 3D printing. Alternately, the section of the frame comprising the first front temple part, the second front temple part, and the front part may be manufactured by fixedly connecting separately manufactured elements to each other, wherein these elements may or may not correspond to the front and the front temple parts. Preferably, the size and shape of the first cavity, the second cavity and the groove are adapted to the size and shape of the elements to be integrated therein.

Electronic glasses according to embodiments may comprise an eyeglass frame comprising a front part, a first temple and a second temple, wherein said temples each comprise a front temple part, of which one end is attached to a side of the front part, and a rear temple part, wherein the other ends of the front temple parts are attached to the respective rear temple parts in such as way that the front temple parts and rear temple parts are movable with respect to each other. They may further comprise an electronic device comprising a first device part, a second device part, a flexible cable configured to provide an electrical connection between the first device part and the second device part and. Furthermore, the glasses may comprise, for each lens being an electro-optical component, a connector suitable for providing an electrical connection between the electronic device and the at least one electro-optical component, preferably a connector according to exemplifying embodiments of the present disclosure. The electronic glasses may further comprise closure means, comprising a sealing element. In these electronic glasses, the first front temple part comprises a first cavity, and the first device part is arranged at least partially in the first cavity, the second front temple part comprises a second cavity, and the second device part is arranged at least partially in the second cavity, and wherein the front part of the frame comprises a groove extending between the first cavity of the first temple part and the second cavity of the second temple part, and the flexible cable is arranged in the groove; the closure means, including the sealing element, are arranged to ensure that the electronic device is enclosed in such a way that it is substantially protected from moisture intrusion or other contamination.

The front temple parts and rear temple parts are preferably movable with respect to each other so that the glasses may be folded and take up less space when stored. The sealing element may be at least partially made of a flexible material. In further embodiments the sealing element is at least partially made of compressible material and/or elastic material. The flexible cable may be configured to be accommodated into the groove and wherein the sealing element is attached on the front part so to seal the flexible cable inside the groove. In some embodiment the flexible cable is configured to be arranged in the first cavity, the groove and the second cavity in order to provide an electrical connection between the first and second device. of the electronic device.

Preferably, the first front temple part and the second front temple part are fixedly attached on either side of the front. The front part, the first front temple part and the second front temple part may be embodied as a single element, preferably manufactured by injection moulding, milling, or 3D printing; alternately, the section of the frame comprising the front part, the first front temple part and the second front temple part may include a plurality of elements fixedly connected to each other, preferably by welding, gluing, or heating and pressing, which elements may, but need not, correspond to the front part and the front temple parts.

The connections between the front temple parts and the respective rear temple parts may be hinged connections.

The electronic glasses may further comprise lenses fitted in eyepieces included in the front part of the eyeglass frame, wherein at least one of the lenses comprises an electro-active lens system. The frame may then comprise, for each eyepiece fitted with a lens comprising an electro-active lens system, a passage and/or groove from the cavity of the first and the second cavity closest to this lens, to the edge of this lens. The electronic device is then electrically connected to the electro-active lens system through this passage/groove. For instance, this may be achieved by the electronic device comprising, for each electro-active lens system, a connector, arranged through the groove to electrically connect the electronic device and the electro-active lens system.

One of the first device part and the second device part may comprise a power supply device, and then the other of the first device part and the second device part may comprise a printed circuit board (PCB), preferably a flexible printed circuit (FPC).

The closure means may comprise at least one interface element, wherein the interface element is preferably an element configured to allow a user to input a command for the electronic device; to output information from the electronic device to a user; or to allow power transfer to the electronic device. Interface elements for input may for instance include buttons or other input means which allow a user to control the electronic device; interface elements for output may include visual output means, such as a window through which a user can see a led on the electronic device or an LCD screen, but are not limited thereto and could also for instance include audio output means; interface elements for power transfer may include charging contacts to enable charging of a power supply included in the electronic device without needing to remove the electronic device from the eyeglass frame or needing to remove or open the closure means.

The sealing element may comprise a compressible and/or elastic front section, arranged in and/or over the groove, thereby providing a sealed channel for the flexible cable.

The closure means may comprise a first lid and a second lid, wherein the first lid is arranged to cover the first cavity and to enclose the first device part between the first lid and the first cavity, and wherein the second lid is arranged to cover the second cavity and to enclose the second device part between the second lid and the second cavity, and sealing material may be provided between each of the said lid and said corresponding front temple parts to render the cavity protected from moisture intrusion or other contamination, said sealing material being optionally part of or attached to the sealing element covering the groove. The sealing material may be embodied as a first compressible and/or elastic ring and a second compressible and/or elastic ring, wherein the first ring is arranged between the first lid and the first cavity to provide a moisture resistant seal, and the second ring is arranged between the second lid and the second cavity to provide a moisture resistant seal.

In embodiments including both the elastic and/or compressible front section and the first and second rings, these are preferably manufactured as a single part, for instance out of a rubber or silicone/elastomer material. This may improve the sealing properties, and thus improve the protection of the electronic device from moisture intrusion.

In other embodiments, the closure means and the electronic device form a sub-assembly, wherein preferably the electronic device is substantially protected from moisture intrusion or other contamination in the sub-assembly. This sub-assembly is fastened to the eyeglass frame as a whole, preferably in a removable manner. This may be achieved for instance by the closure means comprising a first housing and a second housing, wherein the first housing is arranged to enclose the first device part and is fastened at least partially in the first cavity, preferably using a snap-fit connection, and wherein the second housing is arranged to enclose second device part and is fastened in second cavity, preferably using a snap-fit connection. This makes it possible to pre-assemble the electronic device and closure means in such a way that the electronic device may be protected from moisture intrusion even prior to its being integrated into the eyeglass frame. The sealing element is then preferably configured to encapsulate the flexible cable, such that the combination of the first housing, the second housing and the sealing element substantially protects the electronic device from moisture intrusion or other contamination. If a snap-fit connection is desired, this may require the cavities and the housings comprising complementary fastening means allowing them to establish a snap-fit connection.

Advantageously, the flexible cable may comprise a flexible PCB.

The closure means may be fastened to the frame using screws, a moisture resistant adhesive, and/or any other appropriate fastener.

The frame may comprise at least one of plastic, preferably injection-moulded plastic; acetate; and a 3D-printable material.

The electronic glasses according to exemplifying embodiments of the present disclosure may include an electronic pre-assembly for integration into an eyeglass frame provided with a first cavity in a front temple part of the first temple, a second cavity in a front temple part of the second temple, and a groove on the rear side of the front part, preferably for use in the previously described method and/or resulting in electronic glasses as described above. The electronic pre-assembly comprises an electronic device comprising a first device part, a second device part, and a flexible cable, preferably a printed circuit board (PCB) or a flexible printed circuit (FPC) cable, configured to provide an electrical connection between the first device part and the second device part; a first housing arranged to enclose the first device part and configured to be fastened at least partially in the first cavity; and a second housing, arranged to enclose the second device part and configured to be fastened at least partially in the second cavity.

Using this pre-assembly, makers of glasses then only need to manufacture a suitable eyeglass frame—which may be designed for this purpose with appropriately sized and shaped cavities and an appropriately sized and shaped groove, or which may be adapted from an existing design to include these cavities and this groove—to be able to produce electronic glasses as described above, by fastening the pre-assembly thereto.

The flexible cable may be encapsulated by a compressible and/or elastic material, such that the electronic device in the pre-assembly is already protected against moisture intrusion. At least one of the first housing and the second housing may comprise at least one interface element, wherein the interface element is preferably an element configured to allow a user to input a command for the electronic device; to output information from the electronic device to a user; or to allow power transfer to the electronic device.

An electronic device included in the electronic glasses according to exemplifying embodiments of the present disclosure may further comprise, or be connected/connectable to at least one connector suitable for providing an electrical connection between the electronic device and an electro-active lens system in a lens fitted into the eyeglass frame, such as a connector according to exemplifying embodiments of the present disclosure. Such a pre-assembly is then suitable for use with a frame fitted with at least one electro-active lens system.

To manufacture electronic glasses according to exemplifying embodiments of the present disclosure, a kit may be provided comprising an electronic device comprising a first device part, a second device part, and a flexible cable, preferably a flexible printed circuit board (PCB), configured to provide an electrical connection between the first device part and the second device part; and closure means comprising a first lid configured as a cover for the first cavity, a second lid configured as a cover for the second cavity, and a sealing element, wherein the sealing element is preferably at least partially made of a flexible, compressible and/or elastic material, and more preferably comprises a compressible and/or elastic front section configured to fit in and/or over the groove to form an enclosed channel. Like the pre-assembly, such a kit makes it possible for makers of glasses to produce electronic glasses by manufacturing a suitable eyeglass frame and then integrating the electronic device into it using the closure means.

To ensure that the electronic device is protected from moisture intrusion, the sealing element may further comprise a first compressible and/or elastic ring and a second compressible and/or elastic ring, wherein the first ring is configured to be arranged between the first lid and the first cavity to provide a moisture resistant seal, and the second ring is configured to arranged between the second lid and the second cavity to provide a moisture resistant seal, wherein the sealing element is preferably manufactured as a single part, preferably out of a rubber or silicone material.

Preferably, at least one of the first lid and the second lid comprises at least one interface element, wherein the interface element is preferably an element configured to allow a user to input a command for the electronic device; to output information from the electronic device to a user; or to allow power transfer to the electronic device.

In some embodiments, the electronic glasses further comprise at least one connector suitable for providing an electrical connection between the electronic device and an electro-active lens system in a lens fitted into the eyeglass frame. Preferably, this is a connector according to exemplifying embodiments of the present disclosure.

The kit may further comprise fastening means configured to fasten the first lid on the first cavity and the second lid on the second cavity, the fastening means preferably further configured to fasten the first device part in the enclosure formed by the first cavity and the first lid and to fasten the second device part in the enclosure formed by the second cavity and the second lid.

For any electronic glasses according to exemplifying embodiments of the present disclosure, it may be advantageous to standardize the shapes and sizes of the cavities and groove, of the electronic device, and/or of the closure means, such that elements may be interchanged between different embodiments. This could allow a consumer to assemble electronic glasses as desired. For instance, if there is a range of frames provided with the same of similarly configured cavities and groove, a user may choose a frame based on aesthetic preferences, or transfer an electronic device to a different frame. If different electronic devices are configured to have a similar shape and size, the user may then select an electronic device based on a desired function; or could even for some embodiments use the same frame for different purposes, by switching the electronic device. Closure means could be provided in different colors, for instance to suit different frames, and/or may include suitable input means, output means and/or charging means adapted to a given electronic device and/or to a user's preferences.

It may additionally be advantageous to configure the cavities in such a way that the electronic device and the closure means may be arranged in two different ways, i.e. either with the first device part arranged to the first cavity and the second device part to the second cavity or vice versa.

The above is presented as additional information regarding possibilities to manufacture the electronic glasses according to exemplifying embodiments of the present disclosure, as well as any other electronic glasses for which the connector according to exemplifying embodiments of the present disclosure may be suitable; as well as elucidating further potential aspects of the claimed electronic glasses. However, the above should not be taken as limiting; the scope of the present disclosure is defined by the appended claims, any embodiments not failing under the scope of the claims should be interpreted as examples useful for understanding the disclosure.

To further understand the disclosure, the figures will be described in more detail below. Note that like reference numerals are used for like parts in the following description. A list of all used numerals and a brief description thereof can be found at the end of this description.

FIGS. 1, 2, 3, 4A and 4B illustrate one possible embodiment of electronic glasses for which the claimed connector may be suitable.

FIG. 1 shows an exploded view in perspective, to be able to illustrate the various elements of the glasses. An eyeglass frame 100 comprises a front part 103, with on the left side a left front temple part 101 and a left rear temple part 151 and on the right side a right front temple part 102 and a right rear temple part 152. In FIG. 1, hinge 162 is visible, connecting right front temple part 102 and right rear temple part 152 so that the rear temple part can be folded inwards, towards the front part; left front temple part 101 and left read temple part 151 are similarly connected by a hinge (not visible in the figure). Other types of connections which allow the rear temple parts to be folded inwards are known to the skilled person in the field of (normal) eyeglass design.

A first or left cavity 111 (not visible) is provided in left front temple part 101; a second or right cavity 112, of which the shape may mirror the shape of the first/left cavity but which may also have a different shape, is provided in right front temple part 102. The size, shape and dimensions may differ from what is depicted, and will be adapted to the size, shape and dimensions of the electronic device 200 and the closure means 300. The cavities may for instance be more shallow than depicted here, as it is not required for electronic device 200 and closure means 300 to be fully taken up in the space that would, absent a cavity, be occupied by the front temple part. It is sufficient that the cavity can receive electronic device 200 and closure means 300 at least in part, and can serve as an anchoring point therefore. In the depicted embodiment, second/right cavity 112 includes a threaded opening 122, suitable for a screw to be screwed into it, but many alternative or additional fastening means are also possible. Correspondingly, the first/left cavity, which is not visible in FIG. 1, comprises a second threaded opening.

The front part 103 comprises a left eyepiece 131 with a left lens 171; a right eyepiece 132 with a right lens 172; and a bridge 133 connecting eyepieces 131, 132, and further is provided with a left nosepad 141 and a right nosepad 142 for comfortable support of the glasses on user's nose.

As is well-known to the aforementioned skilled person in the field of eyeglass design, various other forms of frames 100 are possible, for instance with differently shaped eyepieces, a different type of bride, or wherein the nosepads are embodied as ridges on the internal side of the eyepieces. For the present disclosure, any eyeglass frame 100 in which there is sufficient space in the front part 103 to provide a suitable groove and sufficient space in the front temple parts 101, 102 to provide suitable cavities 111, 112 may be used.

Electronic device 200 is depicted in FIG. 1 in an extended state: during the step of integrating the electronic device into the frame, flexible cable 203 will be bent so that first device part 201 may be arranged in first/left cavity 111 and so that second device part 202 may be arranged in second/right cavity 112. In the shown embodiment, first device part 201 consists mainly of a battery 211, preferably a rechargeable battery, on and connected to an electronic substrate, and second device part 202 includes a control unit or controller, for instance comprising a printed circuit board (PCB), but many other arrangements are possible, depending on the intended purpose of the electronic glasses. In the shown embodiment, first device part 201 and second device part 202 further comprise a first aperture 221 and second aperture 222, which can be aligned with the first threaded opening in the first cavity and second threaded opening 122 in second cavity 112, respectively, thereby making it possible to fix first device part 201 and second device part 202 in the respective first and second cavity by a screw; however, many alternative ways of securing the first device part and second device part are also possible.

While this is not shown in the figures relating to this particular embodiment, if the electronic device is a device for control of at least one electro-active lens system, it may further comprise at least one suitable connector for connecting the electronic device to the at least one electro-active lens system. In particular, this connector may be a connector according to the disclosure, which will be described in more detail below.

In the depicted embodiment, closure means 300 include a number of elements, which may be separately provided. In particular, closure means 300 include a sealing element 304 formed of a first/left ring 301, a second/right ring 302 and a front section 303. Closure means 300 further include first/left lid 311, which is provided with first lid opening 321 suitable for first screw 331, and second/right lid 312, which is provided with second lid opening 322 suitable for second screw 332.

The lids further include elements which make it possible to interact with electronic device 200 in various ways. In this particular embodiment, first lid 311, which is intended to cover the first cavity in first front temple part 101 to enclose first device part 201 including its battery 211, includes charging contacts 341, to make it possible to charge battery 211 without needing to remove first lid 311. Second lid 312, meanwhile, is provided with an interface element in the form of output means, specifically in this embodiment a window 342 which may allow light from an LED (not shown) on the PCB to be visible through the lid, thus functioning as a led indicator.

It will be clear that in integrating electronic device 200 into eyeglass frame 100 using closure means 300, first lid 311 and second lid 312, including elements such as charging contacts 341 and window 342, should where needed be chosen to cooperate with the specific first device part 201 and second device part 202 of electronic device 200, e.g. such that a potential window is aligned with a potential led or such that charging contact, after assembly, contact a rechargeable power source so that it may be charged. Lids 311, 312 should furthermore be sized and shaped to function as covers for the first cavity and second cavity 112, respectively, wherein first and second device parts 201, 202, respectively, should fit in the enclosed space that is then created. Likewise, first ring 301 and second ring 302 should be configured such that they may form a moisture resistant seal between lids 311, 312 and an edge of the respective cavity.

Electronic device 200 may be integrated into eyeglass frame 100 by bending flexible cable 203 and arranging first device part 201 in the first cavity and second device part 202 in second cavity 112, such that the threaded openings in the cavities align with the apertures in the device parts. Flexible cable 203 is placed in a groove (not shown in FIG. 1) on the rear side of the front part, preferably such that no part of flexible cable extends from the groove, more preferably not occupying the entire depth of the groove, such that a shallower groove remains present after the flexible cable is placed. At this stage, the connector may also be arranged to provide an electrical connection between exposed contact areas (comprising connection points) on the circumferential rim of the lens and corresponding connection portions of the flexible cable.

Sealing element 304 is then arranged with first ring 301 around an edge of the first cavity, second ring 302 arranged around an edge of second cavity 112, and the front section 303 being fitted into the groove, closing it off—preferably, in the resulting glasses the groove is completely closed, and the surface of front section 303 is flush with the surface of the rear side of front part 103.

First ring 301 and second ring 302 are then fixed by placement of first lid 311 and second lid 312, respectively, and by the fastening thereof by means of screws 331, 332, wherein first screw 331 is inserted through first lid opening 321 and aperture 221 and screwed into the threaded opening in the first cavity, and second screw 332 is analogously inserted through second lid opening 322 and aperture 222 and screwed into second threaded opening 122 in second cavity 112.

The resulting electronic glasses, in which the electronic device is well protected from moisture intrusion due to the seal provided by sealing element 304, is shown in FIG. 2.

FIG. 3 shows a top view of a the disassembled glasses of FIGS. 1 and 2, showing frame 100 with front part 103, including eyepieces 131, 132, bridge 133, and nosepads 141 and 142; left front temple part 101 with first cavity 121 and left rear temple part 151; and right front temple part 122 with second cavity 122 and right rear temple part 152; showing electronic device 200 including first device part 201 with battery 211 and aperture 221, second device part 202 with control unit 212, for instance a PCB, and aperture 222; and flexible cable 203 connecting the two, wherein this cable can be bent to arrange the electronic device in the frame; and closure means 300, including sealing element 304 consisting of first ring 301, second ring 302, and front section 303 connecting the two; lids 311, 312; and screws 331, 332.

FIGS. 4A and 4B are more detailed view, each of half of the previously described embodiment. In particular, FIG. 4A shows first cavity 111 with first threaded opening 121, which cavity is connected to the groove for the flexible cable and to a passage leading to the edge of the first lens and the connection points therein. Note that once lid 311 is positioned as a cover to the cavity and attached with screw 331, with ring 151 or the sealing element arranged between lid 311 and an edge of the cavity, both device part 211 and the passage to the lens will be protected from moisture intrusion. FIG. 4B also shows groove 113, into which flexible cable 203 can be inserted, and which may then be sealed by the compressible and preferably elastic element 303 of sealing element 304. FIG. 4B shows how an input means such as a button may be integrated into the lid and allow a user to input commands to the electronic device. Note that the passage is optional when the connector according to the present disclosure is used.

FIG. 5 and FIGS. 6A and 6B show a different embodiment of electronic glasses, which use an alternate type of connector. FIG. 5 shows the glasses in a state wherein a sub-assembly 500, comprising both the electronic device and the closure means, is not assembled with the eyeglass frame 400. In the shown assembly the sub-assembly forms an integrated sub-assembly of an electronic device and closure means (i.e. the closure means have been integrated with both electronic device parts of the electronic device). This has as an advantage that the sub-assembly, wherein the electronic device is well protected, for instance against moisture, may be provided to a manufacturer of eyeglass frames, and may be easily assembled later, potentially even by a user buying the eyeglass frame and the sub-assembly separately.

Sub-assembly 500 in the shown embodiment comprises first housing 501, enclosing a first electronic device part (not shown) including a battery, and second housing 502, enclosing a second electronic device part (not shown) including a control unit, for instance comprising a PCB or similar arrangement. In the shown embodiment, the housings have apertures 521, 522 so that sub-assembly 500 can be fastened to eyeglass frame 400 by using screws, but it may be preferably to use another fastening method, for instance a snap-fit connection. Connectors 581 and 582, which are suitable to connect the electronic device to electro-active lens systems in lenses fitted in eyeglass frame 400, extend from the housings 501, 502. The sealing element of the closure means in integrated with the flexible cable in that the flexible cable is encapsulated by flexible and/or elastic material protecting the cable against external influences, like moist and the like. Encapsulated flexible cable 504 provides an electric connection between the first device part in first housing 501 and the second device part 502. Advantageously, the cable may comprise or even be embodied as a flexible PCB (FPC).

Eyeglass frame 400 is quite similar to the eyeglass frame described with respect to the embodiment of FIGS. 1-4: in fact, it may be that a same eyeglass frame is compatible with both a sub-assembly such as sub-assembly 500 and with an electronic device and separate closure means as described in conjunction with the embodiment described earlier.

Eyeglass frame 400 comprises front section 403, with lenses 471 and 472 fitted into the eyepieces, wherein these lenses may comprise an electro-active lens system (note that while connection points of these electro-active lens systems are not explicitly depicted here, this should not be seen as indicating their absence). Groove 413 is formed along the top edge of front part 403. Right front temple part 402 includes cavity 412, which is in this embodiment, for the screw connection, provided with threaded opening 422—left front temple part 401 is similarly formed. Passage 492 goes from cavity 412 to an edge of lens 472; a similar passage is provided from the (non-depicted) cavity in the left front temple part to left lens 471. Rear temple parts 451, 452 are attached to the front temple parts 401, 402 through hinged connection 462.

FIG. 6A shows this embodiment in its assembled state. Connector 582 is inserted through passage 492 to connect to connection points 482 in right lens 472. Housings 501, 502 are fastened to the front temple parts by a screw connection, though other connections are possible and may even be preferred.

FIG. 6B shows a cross-section along line A-A indicated in FIG. 6A, which shows that flexible PCB 504C is fully encapsulated by 504B, thus protecting it. It may further be seen that the encapsulated flexible PCB is fitted into the groove: in this embodiment, the groove may comprise recessed sections 525 towards its opening, and the encapsulation 504B of the PCB may comprise corresponding bulges 526: this may assure a more secure retention of the encapsulated PCB in the groove, while still allowing it to be removed from the groove if/when needed.

In the embodiments shown in FIGS. 1-6A the groove 113, 413 extends between the first cavity 111 of the first front temple part and the second cavity 112 of the second temple part over substantially the whole length of the front part 403, i.e. over the upper part of the left eyepiece 131, over the bridge 133 and over the upper part of the right eyepiece 132. Furthermore, the groove 113,413 is provided in the inward face of the left eyepiece 131, bridge 133 and right eyepiece 132, i.e. the side facing the eyes of the user when the eyeglass frame is worn by the user.

In the embodiment shown in FIGS. 7A,7B the eyeglass frame similarly comprises a front part 514 comprising a left eyepiece 531 with a left lens 571, a right eyepiece 532 with a right lens 572, a bridge 533 connecting eyepieces 531, 532 (and may optionally a left nose pad and a right nose pad) and a groove 513 (comprised of groove parts 513¹, 513² and 513³ in open connection with each other) extending over substantially the whole length of the front part 514, i.e. over the upper part of the left eyepiece 531, over the bridge 533 and over the upper part of the right eyepiece 532, but in the bridge 533 the groove 513² is provided in the inward face 552 of the bridge 533 whereas in the left and right eyepiece 531, 532 the groove 513 is provided in the respective radially inwardly directed circumferential surfaces 541 and 542 (i.e. the surfaces facing the lenses 571 and 572). This has a number of advantages. First of all, the thickness (i.e. the height h) of the upper part of the left eyepiece 531 and the upper part of the right eyepiece 532 can be reduced. Secondly, by providing the groove 513 (i.e. the groove parts 513¹ and 513³) in the inwardly directed circumferential surfaces 541, 542 the groove parts 513¹ and 513³ may be sealed off from the environment by positioning the lenses 571,572 on top of or slightly inside the groove thereby fully covering the groove parts. The (bridge) part 513² of the groove 513 present in the bridge 533 in this case may be sealed off from the environment (with the cable 503 arranged inside the groove 513) by placing a sealing element 550, preferably a sealing element comprised of a compressible and/or elastic material, on and/or or inside the groove part 513². Furthermore, this makes it possible to advantageously use the connector according to embodiments of the present disclosure.

In FIG. 7C a variant of the embodiment of FIGS. 7A and 7B is depicted. The groove 513 is not only comprised of groove parts 513¹, 513² and 513³ in open connection with each other, but also groove parts 5135 (one at the left-hand side and one at the right-hand side). Groove parts 5135 are in open connection with respective groove parts 513¹ and 513² and allow the flexible cable 504 (denoted in in dotted lines) to be connected to the control unit and/or battery inside the first or second housing 805, 806. Furthermore, both the left front temple part 801 and right front temple part 802 comprise a hook-shaped end 811 that can be accommodated inside a small cavity 812 arranged inside the left eyepiece 531 and the right left eyepiece 532. The function of the screws 515 slightly changes. The front temple parts 801, 802 are now mainly held in place by the hook-shaped ends 811 that are configured to be slid into the respective cavities 812. The screws 515 are provided for extra fixation. In even further embodiments, for instance in embodiments wherein the cavity and hook-shaped ends are suitably shaped to form a snap-connection, the screws 515 can be dispensed with. A further difference with the embodiment of FIGS. 7A and 7B is that cover 814 is fixed to front part (i.e. first cover 814 at the left-handed side is connected to or integrally formed with the left eyepiece 531 (cf. FIG. 7A) and a second cover 814 at the right-handed side is connected to or integrally formed with the right eyepiece 532).

In the embodiment of FIG. 6A the electrical connectors comprise electrical wires 581, 582 arranged in a passage 492 providing an open connection with the cavity 412, the electrical wires forming electrical connections (only the outer ends being shown in the figure) with the connection points in the respective electro-active lenses 471,472. As is (partially) shown in FIGS. 5 and 6A, the electrical wires 582 of the electrical connector of the right electro-active lens 472 may extend as separate wires from the electronic device (for instance, the controller) in the second housing 502 via the passage 492 towards the electrical connections of the right lens 472 and as separate wires from the same electronic device via the passage 492 and the groove 413 to the electrical connection points in the left lens 471.

This may have disadvantages. In other embodiments, for instance embodiments similar to those of FIGS. 7A and 7B, a connector according to the present disclosure may advantageously be used, leading to a more robust and shock-resistant electrical connection. In these embodiments the cable 504 comprises a plurality of electrical connections and connection portions so as to be able not only to provide a supply voltage from the battery inside the first housing 501 to the control unit in the opposite second housing 502, but also to provide control signals for controlling the left and right electro-active lenses 471, 472 from the control unit in the second housing 502 to the respective exposed contact areas in the respective lenses 471, 472.

In mounted position of the embodiment of FIGS. 5, 6A and 6B, the electrical wires 581,582 are connected to the connection points so as to provide electrical contact between the electrical connection point and the second device part 202 (for instance the control unit 212 (PCB).

In the embodiment of FIGS. 7A and 7B, however, such passage can be dispensed with and the connector 583,584 can be fully accommodated inside the respective groove part 513¹,513³. Alternatively or additionally, if the connection points 482 are provided at the radially outwardly directed circumferential surfaces of the lens 471,472, then the connector 583,584 can be made to directly contact the connection points 482 (i.e. separate electrical wires can be dispensed with), for instance by placing the connector 583, 584 directly on top of the connection points 482 of the lens 471,472. In these cases the connector 583, 584 may form an integral part of the cable 503, more specifically be an integral part of the flexible printed circuit (FPC) cable. The manufacturing of the eyewear can be simplified and/or the risk of defects in the electrical connections can be reduced even further.

In the embodiment of FIGS. 7A and 7B the eyeglass frame comprise a front part 514, a left front temple part 801, a right front temple part 802, a left rear temple part 851 and a left rear temple part 852. Each of the rear temple parts 851, 852 comprises a first rear temple part 871 and a second rear temple part 870. The first and second rear temple parts are shown here as separate parts, although in other embodiments the first and second rear temple parts 870,871 are integrated.

The front temple parts 802,803 may be fixedly connected to the associated front part 514 (through connection elements such as screws 515 arranged at an outer end of the front temple part). The other ends of the front temple parts 802,803 are attached to the respective rear temple parts 851,852 in such as way that the front temple parts and rear temple parts are movable with respect to each other. Whereas the connections between the front temple parts and the respective rear temple parts of the embodiments of FIGS. 1-6A are hinged connections, the connections between the front temple parts 802, 803 and the respective rear temple parts 851, 852 of the embodiments of FIGS. 7A-7B are slidable connections: the rear temple parts 851,852 may be slid over the upper outer surface 809 and lower outer surface 810 of the first housing 805 of the left front temple part 801 and the second housing 806 of the right front temple part 802 and then connected to each other using screws 820.

FIG. 8 is a detailed back side view of a part of the groove 513 shown in FIGS. 7A and 7B. The figure shows that a lower part 901 of both the left eyepiece 531 and the right eyepiece 532 are provided with a groove part 513⁴. Furthermore, the lower part 901 can be manually bent slightly downward (see arrow 900) so as to widen the groove part 513⁴. This makes it possible for a user to easily insert the flexible cable 504 into the groove 513⁴. The lower part 901 then bends back to its original position so that the flexible cable 504 then is maintained firmly inside the groove part 513⁴.

Note that while the figures only show the front temple parts attached to the front part, and while in embodiments the front part and the front temple parts may indeed be manufactured together, this is not a requirement. In fact, for certain choices of materials and/or certain frame designs, it may be preferably to manufacture the front part and the front temple parts separately, and to later assemble them. It may also be possible to have a first element including the front part and a subsection of the front temple parts, with the remainder of the front temple parts being manufactured separately and assembled later; likewise, it may be possible to include subsections of the front part in separately manufactured elements further comprising the front temple parts, etc.—in other words, the border between the front part and the front temple parts need not correspond exactly to the edges of separately manufactured parts.

As an example, in some embodiments, a first element may correspond to the front part, or include both the front part with the groove and a subsection of the front temple parts and the cavities therein. This first element may for instance advantageously be milled, for instance CNC milled, from an acetate slab. Second elements, which each include the remainder of a front temple part and a cavity, may then be made either also of milled acetate, or may be manufactured in a different way: for instance, they may be manufactured by injection moulding a plastic material, by 3-D printing a suitable material, or even made of metal. These second elements are then attached to the first element in a way that is suitable for the material or materials used: for instance, through gluing or—if possible—welding. Third elements, corresponding to the rear temple, are then also manufactured separately, out of a suitable material which may or may not correspond to the material sued for the first element and second elements, and may for instance be attached to the second elements with hinges.

In the exemplifying embodiments described herein the lens comprises an electro-active lens system, herein also referred to as an electroactive component, that can be used to change the optical characteristics of the lens by appropriate switching the electroactive component. Examples of such electroactive lenses are described in document WO 2019/115606 A1, the content of which is hereby incorporated by reference.

Referring to the embodiment shown in FIGS. 9A-9B (or, for that matter, to any of the embodiments shown in the preceding figures), the lens 960 may comprise of a first lens part 970, a second optically transparent lens part 971. Sandwiched between the first and second lens parts one more (stacked) electroactive lenses are arranged. An electroactive lens may comprise a first and a second optically transparent substrate, for instance optically transparent foils, the optically transparent substrates extending generally parallel to each other. The electroactive lens 960 may further comprise a first optically transparent electrode 961 formed on the first lens half or, more generally, on the first optically transparent substrate, and a second optically transparent electrode 962 formed on the second lens half or on the second optically transparent substrate, a sealed cavity 963 between the first and second optically transparent electrodes 961, 962 and a diffractive lens structure (not shown), such as a Fresnel lens structure, connected to the second optically transparent electrode 962. When throughout the present disclosure reference is made to the first and second optically transparent substrates this can relate to embodiments wherein one or more pairs of optically transparent substrates have been placed between two lens parts (i.e. in embodiments wherein the optically transparent lens parts 970, 971 in fact form a passive lens and the optically transparent substrates, optically transparent electrodes and the cavity with the diffractive structure together form an active lens) and to embodiments wherein the substrates (i.e. only the outermost substrates in case of two or more stacked pairs of substrates) actually form the lens parts.

In the sealed cavity 963 at least a liquid crystal layer of liquid crystalline (LC) material is arranged. Preferably the liquid crystalline material is nematic liquid crystal (LC) material, although the use of other types of crystalline material is also possible. Furthermore, in embodiments of the present disclosure, liquid crystals in the liquid crystalline (LC) material are generally axially aligned.

The first and second transparent electrodes 961,962, may be comprised of electrically conductive electrode layers between which the cavity 963 is formed, for instance layers made of ITO material, and electrically conductive lines extending from the electrically conductive electrode layers to the contact areas arranged in the circumferential edge of the lens, for instance electrically conductive Ag lines screen printed on top of the electrically conductive electrode layers). To the first and/or second optically transparent electrodes 961, 962 a suitable electrical voltage may be applied, for instance by connecting the electrically conductive lines with a voltage source, which causes the optical power of the electroactive lens to change by the change of the refractive index of the liquid crystal LC layer in the transverse direction.

As is shown in FIGS. 9A and 9B wherein the circumferential rim 972 of the lens 960 comprises a circumferential bevelled edge or rim 965 into which the first and second optically transparent electrodes 961, 962 extend. Exposed contact areas are formed in the circumferential bevelled edge 965 by removing one or more portions thereof. In the embodiment shown in FIGS. 9A and 9B the exposed contact areas 966, 967 associated with respectively the first optically transparent electrode 961 and the second optically transparent electrode 962 have been formed by removing the edge 965 at the upper section of the lens to form one or more essentially flat lens surfaces 964. In other embodiments, for instance in the embodiment of FIGS. 13A-13E and FIG. 14 the exposed areas are formed by drilling respective holes in axial direction through one side of the circumferential bevelled edge 965, as will be explained later. The exposed contact areas 966, 967 provide electrical contact with respectively the first and second optically transparent electrodes 961, 962 of the electro-active optical component.

As mentioned above, FIGS. 9A-9F also illustrate one possible embodiment of a connector 983 according to an exemplifying embodiment. FIGS. 9A and 9C show this embodiment in an exploded view. The lens 960 has two exposed contact areas 966 and 967. Shown above the two exposed contact area 966 and 967 various parts of the connector 982: from bottom to top, this includes first housing 911 of sealing unit 910, connection element 981, compressible connector module 982, flexible cable 904, second housing 912 of sealing unit 910, and a portion of the frame 920, specifically a portion of the top of an eyepiece 931, including groove 913 in the radially inwardly directed circumferential surface 941.

As can be seen in particular in FIG. 9A, the radially outwardly directed circumferential surface of lens 960 is bevelled—specifically, in this embodiment, the entire circumferential surface includes a bevel, except for the section which is to receive connector 983. While other options are also possible, there are a few advantages to such an arrangement: the removed section may provide access to electro-active component and/or may help position connector 983, of which the size and shape are preferably adapted to the size and shape of the removed area of the bevel. While two exposed contact areas 966, 967 are depicted, there could of course be more.

First housing element 911 of sealing unit 910, which is preferably made of a water-impervious, resilient, flexible, insulating material, provides a few different functions. Firstly, its circumferential ring plays a part in achieving the desired moisture resistance, in particular for connection element 981, compressible connector module 983 and for the flexible cable 904. Secondly, insulating portions 969, which is a sort of ‘dam’ in the middle of first housing element 911 which divides it into two openings 913, 914, when connector 983 is placed on the lens 960, electrically insulates the two exposed contact areas 966, 967 from each other. Note that the shape is such that these functions can be performed for different positions of the exposed contact areas (different lenses tend to have different positions of the contact areas), as long as one the first housing element is arranged such that one of its openings 913 is arranged over the first contact area 966, another opening 914 is arranged over the second contact area 967. In case there are more than two contact areas, preferably there are also more than one opening, which may be delimited by additional insulating ‘dams’.

Connection element 981 here comprises a small flexible printed circuit board, FPC, but many other options are also available, such as for instance the use of (partially) conductive tape, preferably a pressure sensitive adhesive (PSA) transfer tape.

A not-limiting example of conductive tape is Electrically Conductive Adhesive Transfer Tape (ECATT) 9703 by 3M™. This tape is a is a pressure sensitive adhesive (PSA) transfer tape with anisotropic electrical conductivity. The PSA matrix is filled with conductive particles which allow interconnection between substrates through the adhesive thickness (i.e. in the z-direction) but are spaced far enough apart for the tape to be electrically insulating in the plane of the tape.

As shown in FIG. 9B the connection element 981 further comprises an amount of an electrically conductive adhesive (glue) 968, for instance Ag glue. The flexible printed circuit board, FPC, includes conductive connection portions 984 arranged in a non-conductive element. The embodiment depicted here has ten conductive portions, divided into two groups of five, which makes the depicted connector 983 suitable for lenses with any of four possible (approximate) positions of the exposed contact areas 966, 967, but this is of course only an example. There could be more or fewer conductive portions, and the connection element 981 could also be an element that is conductive only in the z-direction.

The compressible connector module 983 in this embodiment may be a so-called z-axis connector module, for instance a connector module of the type sold under the name ZEBRA®, or another type of elastomeric connector module. For instance, the elastomeric z-axis connector module may be comprised of alternating conductive and insulating regions, wherein the conductive regions may be made of conductor material such as carbon, silver, and/or gold and the insulating regions may comprise a rubber or elastomer matrix to produce overall anisotropic conductive properties. For instance, the compressible connector module may comprise alternating conductive and insulating layers of silicone rubber, cut crosswise to expose the thin layers, thereby providing high-density redundant electrical paths for high reliability connections in the z-direction only. Although the compressible connector module 983 may take any shape, although the compressible connector modules often are block-shaped or strip-shaped.

The compressible connector module 983 may be configured to be resiliently compressible in its thickness direction (herein also referred to as the axial direction or z-direction). Additionally the compressible connector module 983 may be configured to be electrically conductive in the thickness direction, and electrically insulating in lateral directions (i.e. in a lateral (x,y) plane extending perpendicular to the thickness direction).

Note that in other embodiments than the embodiment shown in FIGS. 9A and 9B one or more of the first housing 911 and connection element 981 may be combined or omitted. Furthermore, in the shown embodiment there is one single compressible connector module for connection with both the first and second electrode 961, 962. This is possible if the compressible connector module 983 is of a type that is conductive in the z-direction (i.e. the axial direction or thickness direction) and isolating in the x,y direction (i.e. the lateral direction). In other embodiments two or more compressible connector modules are employed, preferably one or more modules for connection with the first electrode 961 and one or more other modules for connection with the second electrode 962.

Flexible cable 904, which may be an FPC, is connected or connectable to the control unit 212 for the electroactive element, and was already described in some detail above. The flexible cable 904 includes conductive connection portions 984 (cf. FIG. 9C) which, when an electrical connection to the exposed contact areas is established, allows for control of electro-active component 971′.

Second housing element 912 takes the form of a larger overmould, which includes slit-shaped openings 956 at each end so that the second housing element 912 may be slid over the flexible cable 904, or conversely so that flexible cable 904 may be inserted through these openings. Second housing element is preferably at least partially made of a resilient material. The slit-shaped openings are preferably configured so that, when the flexible cable is inserted through them, the edges of the openings are closely conformed to the surface of the flexible cable, so that no moisture may enter through these openings to the interior of connector 983. Second housing element 912 further includes at least a circumferential ring-shaped flange 957 which is able to surround the interior of connector 983 and to thereby protect the interior of the connector 983 from moisture; it may further include elements to electrically insulate certain areas of the flexible cable from other areas of the flexible cable, if deemed needed.

All parts of the connector 983 are adapted to fit into groove 913, which is provided in the eyepiece of the frame 920. Some or all of the flexible/compressible elements may be adapted so that they must be at least somewhat compressed to fit into the groove, which may lead to a more robust and shock-resistant result. It may in particular be advantageous if the ‘empty’ space in the groove 913, once the elements are arranged therein, is limited, in particular that there is little to no empty space between flexible cable 904 and the surface of lens 960, to prevent oxidation of the electrically conductive elements. The groove 913 and the connector 983 may be sized so as to allow the connector 983 to snugly fit inside the groove.

There are of course various alternatives for the specific parts shown. As mentioned earlier, a single compressible connector module (for instance a z-axis connector module) may be used, rendering either or both of first housing element 911 and connection element 981 in the form of a FPC superfluous. Another alternative is to use two or more compressible connector modules, a first one for connection with the first electrode and a second one for connection with the second electrode. These compressible connector modules may be of elastomeric z-axis connector modules, but could also be of a different type, such as SMD type flexible connector modules (for instance, SMD contact pads, having a generally W shape and/or having a silicone rubber core covered with a conductive (solderable) film). As mentioned before the connection element 981 could be absent, or could be formed by at least one of an FPC, a conductive adhesive such as a glue pads, preferably Ag glue pads, and a conductive tape.

FIG. 9B shows a cross-section of all the above-described parts in their assembled arrangement, along a plane perpendicular to the longitudinal axis of the elements. Electro-active component is visible in lens 960, between transparent substrates 970, 971. In particular, this figure shows an additional connection element in the form of a pocket of conductive material, for instance glue 968—Ag glue, for example—is applied directly on each of the exposed contact areas 966, 967, preferably filling corresponding openings 913, 914 of first housing element 911 over at least the width thereof, i.e. along the front-to-back direction of the eyepiece. This additional connection element establishes an electrical connection between each corresponding exposed contact area 966, 967 and a conductive connection portion 984 (cf. FIG. 9C) of connection element 981, i.e. in this case a small FPC. Compressible connector module 982, here a z-axis connector module, is arranged directly on top of the small FPC 981, and flexible cable 904 is arranged directly on top of that. In FIG. 9B it is most clearly visible how second housing element 912, which here is an overmould, covers and encloses all elements of connector 983, thus protecting the interior from external impact, such as dirt and/or moisture. Second housing element 983 is further configured to fit into groove 913, preferably so that all or most of its outer surface is in contact with the inner surface of groove 913. The elements are configured such that compressible connector module 982 is compressed between the edge 965 of lens 960 and the frame 920.

FIG. 9D is a side view of the same embodiment, in its assembled form, without the frame 920. This figure in particular shows clearly that the removed portion of the bevel is configured to receive connector 983, in particular that its size is adapted to the size of second housing element 912, which forms most of the outside of the connector. This figure also shows flexible cable 904 extending from slit-shaped openings 955 in second housing element 912, further along the circumferential rim or edge 965 of lens 960.

FIG. 9E is a perspective view of the same embodiment, in assembled condition but without the frame; FIG. 9F shows a top view of this embodiment. The figures in particular show that second housing element 912 may include ‘dams’ which may electrically insulate certain portions of the flexible cable from other portions; these sections may further improve the structural integrity of this housing element and improve moisture resistance.

FIG. 10A to 10C show another exemplifying embodiment of a connector 1000 configured to provide an electronic connection between the control unit 212 and at least one electro-optical component arranged in an electroactive lens, more specifically a lens suitable for use in glasses. The figures shown the embodiment in various stages of assembly. FIG. 10C shows flexible cable 1004, including a number of conductive connection portions 1005. Two compressible connector modules 1006 and 1007 are arranged against the conductive connection portions 1005. The compressible connector modules 1006, 1007 are compressible in their direction of thickness. In the embodiment shown the compressible connector modules 1006, 1007 are so-called surface mount device (SMD) connector modules, also known as SMD contact pads—preferably they are SMD contact pads of type W, which have a silicone rubber core covered with a conductive solderable film. The conductive film ensures electrical contact between the conductive contact points 1005 and the conductors provided in the respective exposed contact areas 966, 967 associated with respectively the first optically transparent electrode 961 and the second optically transparent electrode 962 of the electroactive component.

FIG. 10B additionally shows first housing element 1011, which takes the form of a gasket for the two SMD connectors. While this gasket may be manufactured at least partially of a resilient/flexible material, it does not need to be.

Finally, FIG. 10A additionally shows second housing element 1012, which provides a moisture proof enclosure. Second housing element 1012 is quite similar to second housing element 912 described in the context of FIG. 9A-9F, and includes similar slit-shaped openings 1012′ which allow it to be able to be slipped over flexible cable 1004, or conversely which make it possible for flexible cable 1004 to be inserted through it. The resulting connector shown in FIG. 10C may be applied to the circumferential rim of a lens, so that the SMD connectors are applied (directly or indirectly) to exposed contact areas of the lens, and may be inserted in a groove on the radially inward circumferential edge of an eyepiece as described above.

FIGS. 11A-11D show yet another exemplifying embodiment of several parts of a connector 1100. FIG. 11A shows two compressible connector modules 1105 and 1106, which here takes the form of two separate compressible z-axis connector modules 1105 and 1106, for instance of the ZEBRA® type. Each of the z-axis connector modules 1105 and 1106 comprise a non-conductive resilient core 1107 and a number of parallel windings 1108. FIG. 11B shows the sealing unit 1110, which is here embodied as a single flexible housing element which includes two openings 111 and 1112 suitable for receiving respective z-axis connector modules 1105 and 1106. The sealing unit 1110 includes an insulating portion 1013 between the two openings 1111 and 1112, so that the two z-axis are additionally electrically insulated from each other, and additionally so that any conductive portions above or below these openings will be electrically insulated from each other. The longitudinal upper edges of sealing unit 1110 are higher than the edge at either end, to allow flexible cable 1004 to also fit into it. The resulting assembled state of the connector is shown in FIGS. 11C and 11D, wherein 11C is a partially ‘transparent’ perspective view and FIG. 11D shows a cross-section through a plane perpendicular to the longitudinal axis of the connector. Here, it is clear that this is an embodiment having a minimum number of parts: in particular, there is no need for an additional overmould, since the flexible cable 1004 here forms the upper surface of the connector. The z-axis connector modules are enclosed between the circumferential edge 965 of the lens, sealing unit 1110, and the flexible cable 1004, and are in this manner protected from moisture.

FIG. 12A shows a bevelled edge 965 of a lens 960 with a section removed (for instance using an etching, laser cutting or milling technique) to make space for a connector, similar to the lens shown in FIG. 9A-9F. In this embodiment the removed portion of the lens creates a flat lens surface 964 wherein respective conductors (not shown) in exposed contact areas 966, 967 are provided. FIG. 12B shows another option, in which a plurality of smaller sections 964A, 964B, 964C are removed, each exposing a contact area. An advantage of the latter embodiment is that it may aid in precise positioning of the connector(s) (for instance, one connector for each section) such that a reliable electrical connection can be established, but a disadvantage may be that the connector may then require more space on top of the lens.

FIGS. 13A-13E and 14 illustrate yet another exemplifying embodiment of an electroactive lens 1360 with a connector 1300 according to the exemplifying embodiment, in various stages of assembly. FIG. 13A shows a portion of a circumferential rim or edge 1365 of the electroactive lens 1360, which in this embodiment is formed by a radial protrusion extending in a radial direction from the edge of the electro-active lens 1360. The electro-active lens 1360 comprises at least one electro-optical component 1368 that can be controlled to cause a change of the optical characteristics of the lens. Similar to the lenses described earlier, the lens 1360 comprises a first optically transparent substrate 1370, a second optically transparent substrate 1371, wherein the first and second optically transparent substrates extend generally parallel to each other. The electroactive lens 1360 may further comprise a first optically transparent electrode 1361 formed on the first optically transparent substrate 1370 and a second optically transparent electrode 1362 formed on the second optically transparent substrate 1371, a sealed cavity between the first and second optically transparent electrodes 1361, 1362 and a diffractive lens structure (not shown), such as a Fresnel lens structure, arranged inside the sealed cavity and connected to either the first optically transparent electrode 1361 or the second optically transparent electrode 1362.

The circumferential rim or edge 1365 of the electro-active formed by the circumferential radial protrusion of the lens 1360 is not etched, cut or milled away along a certain distance as was the case the embodiments of FIGS. 9A, 12A and 12B, but recesses 1372, 1373 have been provided in one of the upright sides of the circumferential edge 1365, for instance by drilling respective holes, preferably only partway through the thickness of the bevelled edge. These recesses expose contact areas 1385 of the electro-active component(s) 1368 in the lens 1360 present inside the circumferential edge 1365.

FIG. 13B shows both this portion of the lens 1360 and an (optional) connection element 1380, which is for instance in the form of a piece of flexible flat cable (FFC), or flexible PCB, arranged over the outer surface of the edge 1365 and which includes conductive portions 1374 and 1375 which preferably are arranged at the positions of respective recesses 1372, 1373. The recesses have been filled up with conductive (non-adhesive or adhesive) material 1384 (cf. FIG. 14). The connection element 1380 may also be made of sheet of insulating material having openings into which the two conductive portions have been arranged. In other embodiments the connection element 1380 is dispensed with and the conductive portions 1374 and 1375 are directly attached to the circumferential edge 1365 or at least to the conductive material 1384 present in the recesses 1372 and 1373. In each any case a galvanic connection between the outer surface of each of the conductive portions 1374 and 1375 and the respective contact areas 1385 of the lens is to be established.

The figures shows a compressible connector module 1381, arranged over the conductive portions 1374 and 1375. In the shown embodiment the compressible connector module 1381 is an elongated module having a generally U-shaped or V-shaped cross-section. The compressible connector module 1381 is configured to be fittingly placed over circumferential rim (which in the shown embodiment is formed by a circumferential radial protrusion of the lens substrates 1370 and 1371) so that the inner side of the compressible connector module 1381 may be kept in close (electrical) contact with the conductive portions 1374 and 1375 of the connection element 1380 or of the conductive material 1384 arranged in the recesses 1372 and 1373.

Note that the positioning of this connector module along the circumferential direction is less crucial when it is conductive in only the z-direction (i.e. in a direction from the flexible cable 1004 to either of the conductive portions 1374, 1375 and vice versa) over its entire length. In case the connector module allows for conduction in the x-y-plane as well, for instance in the circumferential direction, then use is to be made of two separate connector modules that are electrically insulated from each other: a first connector module for contact between a flexible cable and the first conductive portion 1374 and a second connector module for contact between the flexible cable and the second connector module 1375. This flexible cable is shown as flexible cable 1004 in FIG. 13D and is shown to be placed onto the connector module 1381. The flexible cable 1004 which extends beyond the connector and is connected or connectable to the control unit 212 arranged at a remote location in the frame 920 (not shown). FIG. 13E shows the entire connector 1360, including also sealing unit 1383, which includes slit-shaped openings 1382 through which flexible cable 1004 extends in a sealing manner (i.e. in an manner wherein the part of the flexible cable inside the sealing unit 1383 is completely sealed off from the environment so that no moist or dirt can enter the sealing unit through the slit-shaped openings 1382). Sealing unit 1383 encloses the relevant part of flexible cable 1004, connection element 1380, compressible connector module 1381, and the recesses 1372,1373, and protects all these elements from moisture.

FIG. 14 shows a cross-section of this embodiment, along a plane perpendicular to the longitudinal axis of the connector 1360. In this image, electro-active component 1368 is visible, and in particular it can be seen that recesses 1372, 1373 extend only partially through bevelled edge 1365, specifically to expose electro-active component 1368. Preferably, as indicated earlier, to establish a good electrical connection between the electro-active component 1368 and connection element 1380, recesses 1372,1373 are at least partially filled with conductive material 1384, for instance an adhesive material such as Ag glue, which then is part of the connection element 1380. Other materials and/or elements could also be used to ensure that the conductive portions 1374, 1375 of connection element 1380 electrically connect to the contact areas 1385 on electro-active component 1368 exposed by recesses 1372 and 1373.

In a further embodiment (A1) of the present disclosure an electronic glasses configured to be provided with at least one electro-optical component is provided, the electronic glasses comprising:
an eyeglass frame comprising
   a front part, a first temple and a second temple;
   wherein said temples each comprise a front temple part, of which one end is attached to a side of the front part, and a rear temple part,
   wherein the other ends of the front temple parts are attached to the respective rear temple parts in such as way that the front temple parts and rear temple parts are movable with respect to each other;
an electronic device comprising a first device part, a second device part, a flexible cable configured to provide an electrical connection between the first device part and the second device part and, for each lens being an electro-optical component, a connector suitable for providing an electrical connection between the electronic device and the at least one electro-optical component;
wherein the first front temple part comprises a first cavity, and the first device part is arranged at least partially in the first cavity, the second front temple part comprises a second cavity, and the second device part is arranged at least partially in the second cavity, and wherein the front part of the frame comprises a groove extending between the first cavity of the first temple part and the second cavity of the second temple part, and the flexible cable is arranged in the groove.

In embodiment (A1) each of the first temple and second temple may further comprise a hook-shaped end to be accommodated in respectively a first and second cavity arranged inside the front part (embodiment A2).

In a further embodiment (A3) of the present disclosure the glasses comprises a clamping mechanism configured to apply a mechanical force on the connector so as to clamp the connector module onto the electroactive lens thereby improving the sealing of the connector. The clamping mechanism may be realized by making the frame of flexible material. For instance, if the front of the frame is made in one piece of flexible material like polyamide, the frame may be made flexible enough such that the lenses can be ‘popped-in’. In other embodiments the clamping mechanism is formed by different frame parts that can be placed against each and held against each other by spring action or by attachment means such as one more screws so that the frame parts urge the connector onto the circumferential edge of the lens.

The present disclosure also relates to:

Embodiment A4: Electronic glasses as defined in any of embodiments A1-A3, wherein the frame comprises one or more grooves shaped so as to accommodate at least the flexible cable.

Embodiment A5: Electronic glasses as defined in any of embodiments A1-A4, wherein the groove is arranged in the frame surface facing the user.

Embodiment A6: Embodiment A5: Electronic glasses as defined in any of embodiments A1-A4, wherein the groove is arranged in the radially inwardly directed circumferential surface facing the circumferential rim of the electroactive lens. Embodiment A6: Electronic glasses as defined in any of embodiments A1-A5, comprising a sealing element to be placed in at least a part of the groove to seal the flexible cable inside the groove, wherein the sealing element is at least partially made of a flexible material and/or wherein the sealing element is at least partially made of compressible material and/or elastic material.

Embodiment A7: Electronic device as defined in any of embodiments A1-A6, wherein the electronic device comprises as least one of:
a first device part comprising a battery for providing the at least one electro-optical component with electrical power;
a second device part comprising a controller for controlling the optical characteristics of at least one electro-optical lens;
a flexible cable connecting the battery with the controller;
connections wires for connecting the controller with the at least one electro-optical component.

Embodiment A8: Electronic glasses according to any of embodiments A1-A7, wherein the sealing material is embodied as a first compressible and/or elastic ring and a second compressible and/or elastic ring, wherein the first ring is arranged between the first lid and the first cavity to provide a moisture resistant seal, and the second ring is arranged between the second lid and the second cavity to provide a moisture resistant seal.

The above-described embodiments are merely presented as examples of how a connector according to the exemplifying embodiment may be provided. Various elements of these embodiments could be replaced by alternatives, or in some cases even omitted; functions performed by a combination of elements in one embodiment could be achieved by a single element in another embodiment. Different aspects of different embodiments may also be combined.

1. A connector suitable for providing an electronic connection between a control unit and at least one electro-optical component arranged in an electro-active lens for electronic glasses, wherein the electro-active lens has a circumferential rim along which a plurality of exposed contact areas are arranged for providing electrical contact with the electro-optical component, the connector comprising:
a flexible cable, wherein the flexible cable is configured to be connected to and/or from at least a part of the control unit and comprises connection portions to connect to a compressible connector module;
the compressible connector module, configured to be positioned between the circumferential rim of the electro-active lens and the flexible cable and configured to provide an electrical connection between the plurality of exposed contact areas and the connection portions of the flexible cable, wherein, when the flexible cable is placed in a frame of the electronic glasses and on the circumferential rim of the electro-active lens, the compressible connector module is configured to be compressed between the electro-active lens and the frame; and
a sealing unit configured to enclose at least conductive connection portions of the flexible cable and the compressible connector module when the connector is placed on the electro-active lens.

2. The connector of claim 1,
wherein a size and a shape of the compressible connector module are such that the compressible connector module is able to simultaneously cover all contact areas of the plurality of exposed contact areas, and/or
wherein the compressible connector module is at least partly made of one or more of the following: a resilient material or an elastomeric material.

3. (canceled)

4. The connector of claim 1, wherein the compressible connector module is configured to provide electrical conductance between connection portions of the flexible cable and respective exposed contact areas of the electro-active lens in a thickness direction of the compressible connector module and provide electrical insulation in a lateral plane perpendicular to the thickness direction.

5. The connector of claim 4,
wherein connection portion of the flexible cable is electrically connected to an associated one of the exposed contact areas, and/or
wherein the compressible connector module is configured to be conductive only in a z-direction.

6. (canceled)

7. The connector of claim 1,
wherein the compressible connector module is configured to be conductive only in a z-direction, and
wherein the compressible connector module comprises features listed in one of (i), (ii), or (iii) that follow:
(i) alternating conductive and insulating regions in a rubber or elastomer matrix,
(ii) alternating conductive and insulating regions in a rubber or elastomer matrix and a plurality of compressible connectors, or
(iii) alternating conductive and insulating regions in a rubber or elastomer matrix, a plurality of compressible connectors, and at least one compressible connector for each contact area of the plurality of exposed contact areas.

8. (canceled)

9. (canceled)

10. The connector of claim 1,
wherein the compressible connector module comprises a surface mount device, and/or
wherein the compressible connector module is configured to be compressed in a thickness direction over 0.2 mm to 5 mm when the flexible cable is placed in the frame of the electronic glasses.

11. (canceled)

12. The connector of claim 1, further comprising at least one connection element as defined by one of (i), (ii), (iii), (iv) or (v) that follow:
(i) the at least one connection element is configured to be arranged directly onto at least one of the plurality of exposed contact areas, wherein the at least one connection element is at least partially electrically conductive,
(ii) the at least one connection element is configured to be arranged directly onto at least one of the plurality of exposed contact areas, wherein the at least one connection element is at least partially electrically conductive and comprises electrically conductive adhesive material to be applied to one or more of the exposed contact areas of the electro-active lens,
(iii) the at least one connection element is configured to be arranged directly onto at least one of the plurality of exposed contact areas, wherein the at least one connection element is at least partially electrically conductive and comprises a conductive tape to be applied to one or more of the exposed contact areas of the electro-active lens,
(iv) the at least one connection element is configured to be arranged directly onto at least one of the plurality of exposed contact areas, wherein the at least one connection element is at least partially electrically conductive and comprises a plurality of conductive areas each configured to cover at least one contact area of a plurality of exposed contact areas, or
(v) the at least one connection element is configured to be arranged directly onto at least one of the plurality of exposed contact areas, wherein the at least one connection element is configured to be electrically conductive only over its thickness.

13. (canceled)

14. (canceled)

15. (canceled)

16. The connector of claim 1,
wherein a connection element comprises conductive particles which allow electrical interconnection between connection portions of the flexible cable and exposed contact areas of the electro-active lens in a thickness direction, the thickness direction being a direction perpendicular to a surface of the connection element, and
wherein the conductive particles are spaced far enough apart for the connection element to be electrically insulating in a plane of connection element.

17. The connector of claim 12, further comprising: at least one further connection element,
wherein the at least one further connection element is arranged between the at least one connection element and the compressible connector module, and/or comprises a flexible printed circuit.

18. (canceled)

19. The connector of claim 1,
wherein the sealing unit comprises a flexible housing,
wherein when the connector is placed on the electro-active lens, the flexible housing forms, with the electro-active lens, a waterproof enclosure for at least the connection portions of the flexible cable, the compressible connector module, the exposed contact areas, and,
wherein:
(i) the flexible housing comprises resilient material,
(ii) the flexible housing of the sealing unit comprises a first housing element for accommodating at least the compressible connector module and a second housing element configured to be placed over the second housing element and the compressible connector module accommodated therein, the second housing element configured to further accommodate at least the connections portions of the flexible cable, or
(iii) the flexible housing is a silicone overmold and/or the flexible housing comprises slit-shaped openings through which the flexible cable extends in a sealing manner.

20. (canceled)

21. (canceled)

22. (canceled)

23. The connector of claim 1,
wherein the sealing unit comprises a flexible housing, and
wherein when the connector is placed on the electro-active lens, the flexible cable extends through the flexible housing at least at positions of the connection portions, or the flexible cable extends between the flexible housing and the compressible connector module.

24. (canceled)

25. The connector of claim 1,
wherein the circumferential rim is formed by a circumferential radial protrusion having upright sides, and wherein one or more of the following applies:
(i) recesses are arranged in at least one of the upright sides for exposing respective contact areas on an electro-active element of the electro-active lens,
(ii) the compressible connector module is configured to be placed fittingly over the circumferential radial protrusion, or
(iii) wherein the compressible connector module is U-shaped or V-shaped in cross-section.

26. (canceled)

27. The connector of claim 1,
wherein the sealing unit comprises a first housing element formed by a gasket, or.
wherein the sealing unit is further configured to electrically insulate the plurality of exposed contact areas from each other, or
wherein the sealing unit is configured to seal one or more from among:
the compressible connector module,
the exposed contact areas, and
the connection portions of the flexible cable from an environment.

28. (canceled)

29. (canceled)

30. Electronic glasses, comprising:
a frame;
at least one electro-active lens comprising an electro-optical element and a plurality of exposed contact areas along a circumferential rim of the electro-active lens, each exposed contact area comprising a contact terminal in connection with the electro-optical element;
a control unit for controlling the electro-optical element of the at least one electro-active lens; and
a connector,
wherein the connector comprises:
a flexible cable configured to be connected to and/or from at least a part of the control unit and comprises connection portions to connect to a compressible connector module,
the compressible connector module, wherein the compressible connector module is configured to be positioned between the circumferential rim of the electro-active lens and the flexible cable and is configured to provide an electrical connection between the plurality of exposed contact areas and the connection portions of the flexible cable, and wherein, when the flexible cable is placed in the frame and on the circumferential rim of the electro-active lens, the compressible connector module is configured to be compressed between the electro-active lens and the frame, and
a sealing unit configured to enclose at least conductive connection portions of the flexible cable and the compressible connector module when the connector is placed on the electro-active lens, and
wherein the connector is positioned to provide an electronic connection between the control unit and the electro-optical element of the at least one electro-active lens.

31. The electronic glasses of claim 30, wherein the connector is positioned such that the flexible cable is placed in and/or along the frame, and the compressible connector module is compressed between the electro-active lens and the frame.

32. The electronic glasses of claim 30,
wherein the frame comprises one or more grooves in a radially inwardly directed circumferential surface facing the circumferential rim of the electro-active lens, and the one or more grooves are shaped so as to accommodate at least the flexible cable, or
wherein the compressible connector module is applied directly to the plurality of exposed contact areas, or wherein a connection element of the connector is applied directly to the plurality of exposed contact areas, or
wherein the at least one electro-active lens is arranged for a tuneable transmission of light.

33. (canceled)

34. (canceled)

35. The electronic glasses of claim 32,
wherein an electro-active component of the at least one electro-active lens comprises:
a first and a second optically transparent substrate, wherein the first and second optically transparent substrates extend generally parallel to each other;
a first optically transparent electrode formed on the first optically transparent substrate and a second optically transparent electrode formed on the second optically transparent substrate;
a diffractive lens structure connected to the second optically transparent electrode; and
a sealed cavity between the first and second optically transparent electrodes,
wherein in the sealed cavity at least a liquid crystalline (LC) layer of liquid crystalline (LC) material is arranged,
wherein liquid crystals in the liquid crystalline (LC) material are generally axially aligned; and
wherein the control unit is configured to change an optical power of the electro-active lens by applying a voltage to the first and/or second optically transparent electrode thereby altering a refractive index of the LC layer in a transverse direction.

36. The electronic glasses of claim 35, wherein the plurality of contact areas are exposed areas of the first and second optically transparent electrodes.

37. The electronic glasses of claim 35,
wherein the circumferential rim of the at least one electro-active lens is a circumferential radial protrusion of at least one of the first and second optically transparent substrates, or
wherein the circumferential rim of the at least one electro-active lens is a circumferential radial protrusion of at least one of the first and second optically transparent substrates and the circumferential radial protrusion forms a circumferential bevelled edge into which the first and second optically transparent electrodes extend, and exposed contact areas are formed by removing one or more portions of the circumferential bevelled edge.

38. (canceled)

39. The electronic glasses of claim 31, further comprising a clamping mechanism as defined by one of (i), (ii), (iii), or (iv) that follow:
(i) a clamping mechanism configured to apply a mechanical force on the connector so as to clamp the compressible connector module onto the electro-active lens,
(ii) a clamping mechanism configured to apply a mechanical force on the connector so as to clamp the compressible connector module onto the electro-active lens, wherein the clamping mechanism is formed by the frame, the frame being made of flexible material,
(iii) a clamping mechanism configured to apply a mechanical force on the connector so as to clamp the compressible connector module onto the electro-active lens, wherein the clamping mechanism is arranged in the frame, or
(iv) a clamping mechanism configured to apply a mechanical force on the connector so as to clamp the compressible connector module onto the electro-active lens, wherein the clamping mechanism comprises different frame parts that can held against each other by spring action or by attachment means such as screw so that the different frame parts urges the connector onto the electro-active lens.

40. (canceled)

41. (canceled)
